(19) United States
(12) Patent Application Publication
(10) Pub. No.: US 2014/0133393 A1
(43) Pub. Date: May 15, 2014

(54) METHOD, APPARATUS, AND COMPUTER PROGRAM PRODUCT FOR MULTIPLE MODE IDENTIFIER ADDRESSING

(71) Applicant: NOKIA CORPORATION, Espoo (FI)

(72) Inventors: Chittabrata Ghosh, Fremont, CA (US); Klaus Franz Doppler, Albany, CA (US)

(73) Assignee: Nokia Corporation, Espoo (FI)

(21) Appl. No.: 13/850,956

(22) Filed: Mar. 26, 2013

Related U.S. Application Data
(63) Continuation-in-part of application No. 13/720,796, filed on Dec. 19, 2012.
Application No. 13/720,796 is a continuation-in-part of application No. 13/676,422, filed on Nov. 14, 2012.

(51) Int. Cl. H04W 8/26

(52) U.S. Cl. CPC H04W 8/26
USPC 370/328

(57) ABSTRACT

Method, apparatus, and computer program product embodiments of the invention are disclosed for multiple mode identifier addressing employable, for example, in connection with wireless networks. In an example embodiment of the invention, a method comprises: receiving, at a device, an addressing mode indication from an access node, wherein the mode indication does not alter an association identifier of the device; determining from the addressing mode indication, at the device, an addressing mode to be employed; and operating, at the device, in accordance with the determined addressing mode, wherein the determined mode defines a hierarchical data structure, wherein the association identifier of the device is a manifestation of the hierarchical data structure, and wherein devices are grouped according to hierarchical elements of the hierarchical data structure.

This application is a continuation-in-part of U.S. application Ser. No. 13/720,796, entitled “Method, Apparatus, and Computer Program Product for Association Identifier Addressing and Implicit Target Wake Time Assignment,” which was filed on Dec. 19, 2012, which is a continuation-in-part of U.S. application Ser. No. 13/676,422, entitled “Method, Apparatus, and Computer Program Product for Implicit Target Wake Time Assignment,” which was filed on Nov. 14, 2012, each of which is incorporated herein by reference.

### FIELD

The field of the invention relates to multiple mode identifier addressing employable, for example, in connection with wireless networks.

### BACKGROUND

Modern society has adopted, and is becoming reliant upon, wireless communication devices for various purposes, such as connecting users of the wireless communication devices with other users. Wireless communication devices can vary from battery powered handheld devices to stationary household and/or commercial devices utilizing an electrical network as a power source. Due to rapid development of the wireless communication devices, a number of areas capable of enabling entirely new types of communication applications have emerged.

Cellular networks facilitate communication over large geographic areas. These network technologies have commonly been divided by generations, starting in the late 1970 s to early 1980 s with first generation (1G) analog cellular telephones that provided baseline voice communications, to modern digital cellular telephones. GSM is an example of a widely employed 2G digital cellular network communicating in the 900 MHZ/1.8 GHZ bands in Europe and at 850 MHz and 1.9 GHZ in the United States. While long-range communication networks, like GSM, are a well-accepted means for transmitting and receiving data, due to cost, traffic and legislative concerns, these networks may not be appropriate for all data applications.

Short-range communication technologies provide communication solutions that avoid some of the problems seen in large cellular networks. Bluetooth is an example of a short-range wireless technology quickly gaining acceptance in the marketplace. In addition to Bluetooth other popular short-range communication technologies include Bluetooth Low Energy, IEEE 802.11 wireless local area network (WLAN), Wireless USB (WUSB), Ultra Wide-band (UWB), ZigBee (IEEE 802.15.4, IEEE 802.15.4a), and ultra-high frequency radio frequency identification (UHF RFID) technologies. All of these wireless communication technologies have features and advantages that make them appropriate for various applications.

### SUMMARY

Method, apparatus, and computer program product embodiments of the invention are disclosed for multiple mode identifier addressing employable, for example, in connection with wireless networks.

In an example embodiment of the invention, a method comprises:

receiving, at a device, an addressing mode indication from an access node, wherein the mode indication does not alter an association identifier of the device;

determining from the addressing mode indication, at the device, an addressing mode to be employed; and

operating, at the device, in accordance with the determined addressing mode,

wherein the determined mode defines a hierarchical data structure,

wherein the association identifier of the device is a manifestation of the hierarchical data structure, and

wherein devices are grouped according to hierarchical elements of the hierarchical data structure.

In an example embodiment of the invention, the method further comprises wherein the association identifier is employable for at least two addressing modes.

In an example embodiment of the invention, the method further comprises wherein said hierarchical elements comprise at least one of a page identifier field, a block identifier field, and a sub-block identifier field.

In an example embodiment of the invention, the method further comprises wherein the device learns from the addressing mode indication information regarding lengths of hierarchical elements of the hierarchical data structure.

In an example embodiment of the invention, the method further comprises wherein the addressing mode indication is received via one or more of beacon frame and association response.

In an example embodiment of the invention, a method comprises:

selecting, at an access node, an addressing mode to be employed; and

determining to dispatch, from the access node, to a device an addressing mode indication, wherein the mode indication does not alter an association identifier of the device,

wherein the addressing mode indication conveys said addressing mode to be employed,

wherein said addressing mode to be employed defines a hierarchical data structure,

wherein the association identifier of the device is a manifestation of the hierarchical data structure, and

wherein devices are grouped according to hierarchical elements of the hierarchical data structure.

In an example embodiment of the invention, the method further comprises wherein the association identifier is employable for at least two addressing modes.

In an example embodiment of the invention, the method further comprises wherein said hierarchical elements comprise at least one of a page identifier field, a block identifier field, and a sub-block identifier field.

In an example embodiment of the invention, the method further comprises wherein the addressing mode indication conveys information regarding lengths of hierarchical elements of the hierarchical data structure.

In an example embodiment of the invention, the method further comprises wherein the addressing mode indication is dispatched via one or more of beacon frame and association response.

In an example embodiment of the invention, an apparatus comprises:

at least one processor; and

at least one memory including computer program code, the at least one memory and the computer program code configured to, with the at least one processor, cause the apparatus at least to perform:

receive, at the apparatus, an addressing mode indication from an access node, wherein the mode indication does not alter an association identifier of the apparatus;

determine from the addressing mode indication, at the apparatus, an addressing mode to be employed; and

operate, at the apparatus, in accordance with the determined addressing mode,

wherein the determined mode defines a hierarchical data structure,

wherein the association identifier of the apparatus is a manifestation of the hierarchical data structure, and

wherein devices are grouped according to hierarchical elements of the hierarchical data structure.

In an example embodiment of the invention, the apparatus further comprises wherein the association identifier is employable for at least two addressing modes.

In an example embodiment of the invention, the apparatus further comprises wherein said hierarchical elements comprise at least one of a page identifier field, a block identifier field, and a sub-block identifier field.

In an example embodiment of the invention, the apparatus further comprises wherein the apparatus learns from the addressing mode indication information regarding lengths of hierarchical elements of the hierarchical data structure.

In an example embodiment of the invention, the apparatus further comprises wherein the addressing mode indication is received via one or more of beacon frame and association response.

In an example embodiment of the invention, an apparatus comprises:

at least one processor; and

at least one memory including computer program code, the at least one memory and the computer program code configured to, with the at least one processor, cause the apparatus at least to perform:

select, at the apparatus, an addressing mode to be employed; and

determine to dispatch, from the apparatus, to a device an addressing mode indication, wherein the mode indication does not alter an association identifier of the device,

wherein the addressing mode indication conveys said addressing mode to be employed,

wherein said addressing mode to be employed defines a hierarchical data structure,

wherein the association identifier of the device is a manifestation of the hierarchical data structure, and

wherein devices are grouped according to hierarchical elements of the hierarchical data structure.

In an example embodiment of the invention, the apparatus further comprises wherein the association identifier is employable for at least two addressing modes.

In an example embodiment of the invention, the apparatus further comprises wherein said hierarchical elements comprise at least one of a page identifier field, a block identifier field, and a sub-block identifier field.

In an example embodiment of the invention, the apparatus further comprises wherein the addressing mode indication conveys information regarding lengths of hierarchical elements of the hierarchical data structure.

In an example embodiment of the invention, the apparatus further comprises wherein the addressing mode indication is dispatched via one or more of beacon frame and association response.

In this manner, embodiments of the invention provide multiple mode identifier addressing functionality employable, for example, in connection with wireless networks.

### DESCRIPTION OF THE FIGURES

FIG. 1 discloses a deployment scenario for multiple mode association identifier (AID) addressing functionality in accordance with at least one example embodiment of the present invention.

FIG. 2A discloses a hierarchical addressing for multiple mode AID addressing functionality in accordance with at least one example embodiment of the present invention.

FIG. 2B discloses a further hierarchical addressing for multiple mode AID addressing functionality in accordance with at least one example embodiment of the present invention.

FIG. 2C discloses an additional hierarchical addressing for multiple mode AID addressing functionality in accordance with at least one example embodiment of the present invention.

FIG. 3 discloses TWT hierarchical addressing correspondence in accordance with at least one example embodiment of the present invention.

FIG. 4 discloses an AID-TWT correlation calculation by a station (STA) in accordance with at least one example embodiment of the present invention.

FIG. 5 discloses an AID-TWT correlation calculation by an access point (AP) in accordance with at least one example embodiment of the present invention.

FIG. 6 discloses a further AID-TWT correlation calculation by a STA in accordance with at least one example embodiment of the present invention.

FIG. 7 discloses a further AID-TWT correlation calculation by an AP in accordance with at least one example embodiment of the present invention.

FIG. 8A discloses a further TWT hierarchical addressing correspondence in accordance with at least one example embodiment of the present invention.

FIG. 8B discloses another TWT hierarchical addressing correspondence in accordance with at least one example embodiment of the present invention.

FIG. 8C discloses an additional TWT hierarchical addressing correspondence in accordance with at least one example embodiment of the present invention.

FIG. 9A discloses a further TWT hierarchical addressing correspondence in accordance with at least one example embodiment of the present invention.

FIG. 9B discloses another TWT hierarchical addressing correspondence in accordance with at least one example embodiment of the present invention.

FIG. 9C discloses an additional TWT hierarchical addressing correspondence in accordance with at least one example embodiment of the present invention.

FIG. 10 discloses a hierarchical AID structure in accordance with at least one example embodiment of the present invention.

FIG. 11A discloses a hierarchical AID structure in accordance with at least one example embodiment of the present invention.

FIG. 11B discloses a further hierarchical AID structure in accordance with at least one example embodiment of the present invention.

FIG. 11C discloses an additional hierarchical AID structure in accordance with at least one example embodiment of the present invention.

FIG. 12 discloses a computer in accordance with at least one example embodiment of the present invention.

FIG. 13A discloses a functional block diagram in accordance with at least one example embodiment of the present invention.

FIG. 13B discloses a flow diagram in accordance with at least one example embodiment of the present invention.

FIG. 13C discloses a further flow diagram in accordance with at least one example embodiment of the present invention.

FIG. 14 discloses a further computer in accordance with at least one example embodiment of the present invention.

### DISCUSSION OF EXAMPLE EMBODIMENTS OF THE INVENTION

### Multiple Mode Identifier Addressing—General Functionality

General multiple mode identifier (e.g., association identifier (AID)) addressing functionality according to at least one example embodiment will now be discussed. As discussed in greater detail herein, as a non-limiting example via such functionality a station (STA) may receive from an access point (AP) indication of an addressing mode. The STA may learn from the indication the addressing mode to be employed and/or adjust its operation accordingly. According to at least one example embodiment, a same hierarchical structure (e.g., hierarchical AID structure) may be used for multiple modes (e.g., may be used for all—for instance three—available modes). According to at least another example embodiment, a same length identifier (e.g., AID) may be used for multiple modes (e.g., may be used for all—for instance three—available modes).

As a further non-limiting example, optionally via such functionality a STA (e.g., a non-traffic indication map (TIM) station) receiving (e.g., during association) an AID, and in various embodiments also a discussed-herein duration and/or a discussed-herein AID addressing hierarchy mode indicator (e.g., conveyed via AID bits), may be able to determine therefrom its TWT (e.g., stated as an offset relative to a target beacon transmission time (TBTT)). Optionally, the STA may not receive explicit indication of its TWT, and as such may not receive explicit indication of its TWT during association. Optionally, the STA may specify (e.g., during association) one or more desired TWTs.

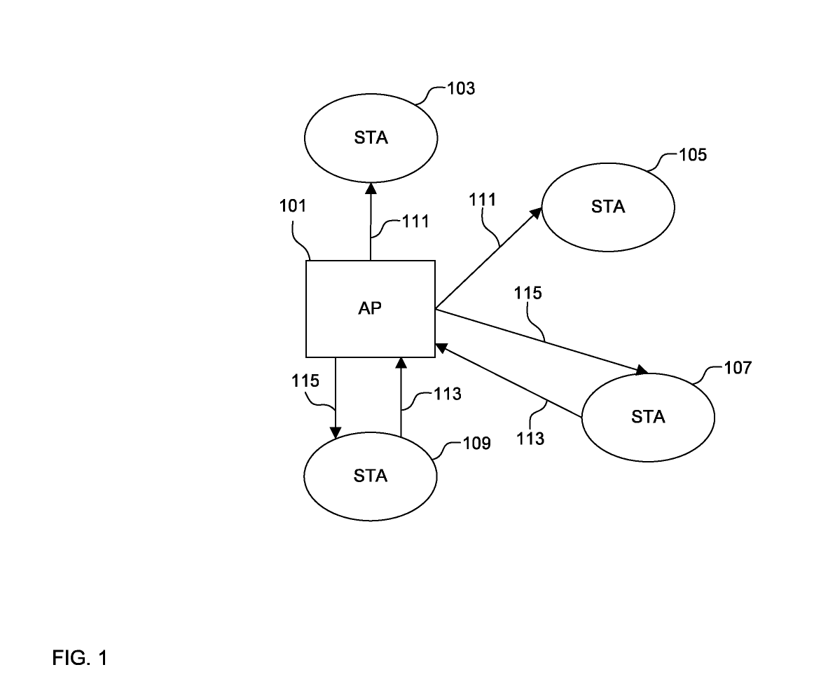

As an illustrative example of such functionality, shown in FIG. 1 is a deployment scenario, according to at least one example embodiment, for the multiple mode AID addressing functionality now discussed. Shown in FIG. 1 are AP (101), TIM STAs 103 and 105, and non-TIM STAs 107 and 109. The Institute of Electrical and Electronics Engineers 802.11ah task group is specifying a network to which at least some embodiments discussed herein may be applied.

Further according to the illustrative example, AP (101) may buffer downlink data for STAs 103-109. TIM STAs 103 and 105 may come to learn that such buffered downlink data awaits them by decoding beacons (111) (e.g., long and short beacons) which may be dispatched by AP (101). Non-TIM STAs 107 and 109, which as a non-limiting example may be power constrained, do not decode such beacons. By not decoding beacons non-TIM STAs 107 and 109 may garner a number of potential benefits including power saving. As a non-limiting example, one or more of STAs 103-109 may be sensors.

Still further according to the illustrative example, non-TIM STAs 107 and 109 each may awaken (e.g., exit a power save mode) at its corresponding TWT and, as appropriate, may perform either or both of dispatching (113) to AP (101) uplink traffic which it may have buffered while asleep (e.g., while in a power save mode) and retrieving (115) downlink data from AP (101) which AP (101) may have buffered while the corresponding non-TIM STA was asleep (e.g., in a power save mode). Optionally, a STA may confirm the absence of traffic (e.g., via carrier sense multiple access (CSMA)) prior to uplink and/or downlink of buffered data at its TWT. In the case where a STA of non-TIM STAs 107 and 109 when awakening both dispatches to AP (101) buffered uplink data and retrieves from AP (101) buffered downlink data, such operations may optionally occur in parallel. In the case of additional non-TIM STAs (e.g., non-TIM STAs beyond non-TIM STAs 107 and 109), such STAs, as a non-limiting example, may analogously dispatch buffered data and/or received buffered data from AP (101) during their corresponding TWTs.

Also according to the illustrative example, a STA may receive from an AP indication of an AID addressing mode and/or may be the subject of implicit TWT assignment based on AID addressing. As a further non-limiting example, the AID addressing may be a hierarchical addressing. The AID addressing may comprise one or more pages. Each page may comprise one or more blocks. Each block may comprise one or more sub-blocks (SBs). Each SB may comprise one or more AID address locations, with each such AID address location perhaps corresponding to the AID of a STA (e.g., with there perhaps being AIDs ranging from 1-2007 with each of multiple STAs perhaps receiving one of the AIDs from that 1-2007 range, with there perhaps being AIDs ranging from 1-2048 in one page with each of multiple STAs perhaps receiving one of the AIDs from that 1-2048 range, and/or with there perhaps being AIDs ranging from 1-8192 with each of multiple STAs perhaps receiving AIDs from that 1-8192 range). In at least one embodiment, there may be more or less hierarchy levels in AID addressing.

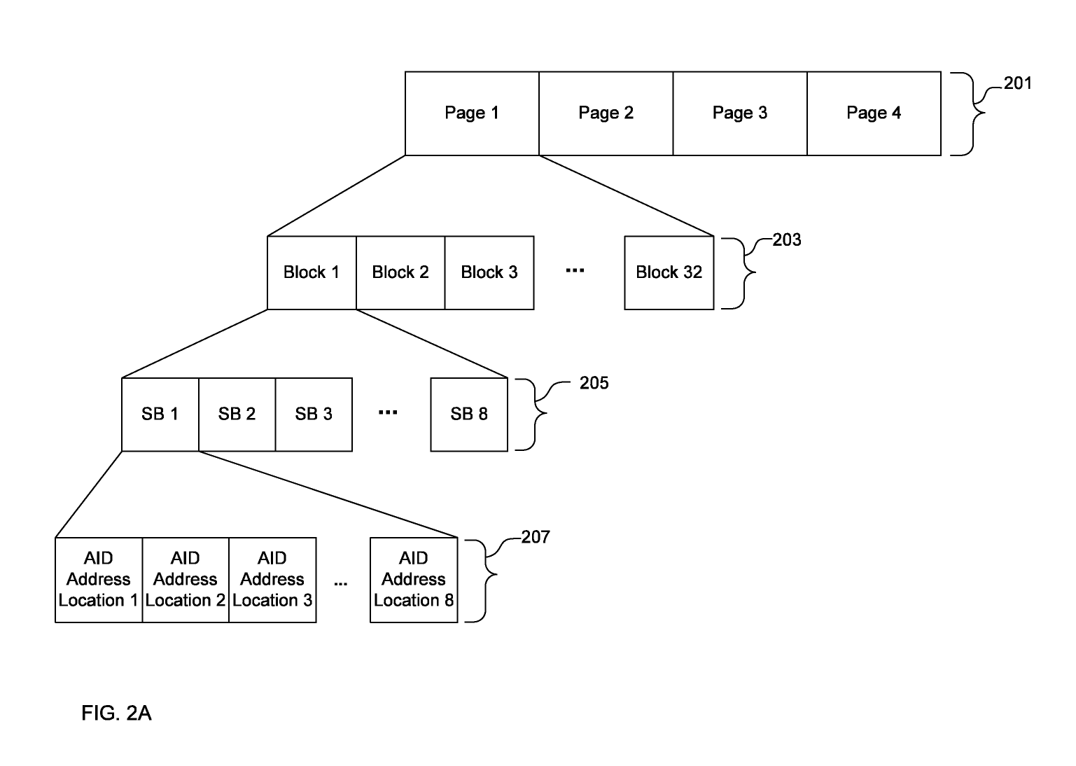

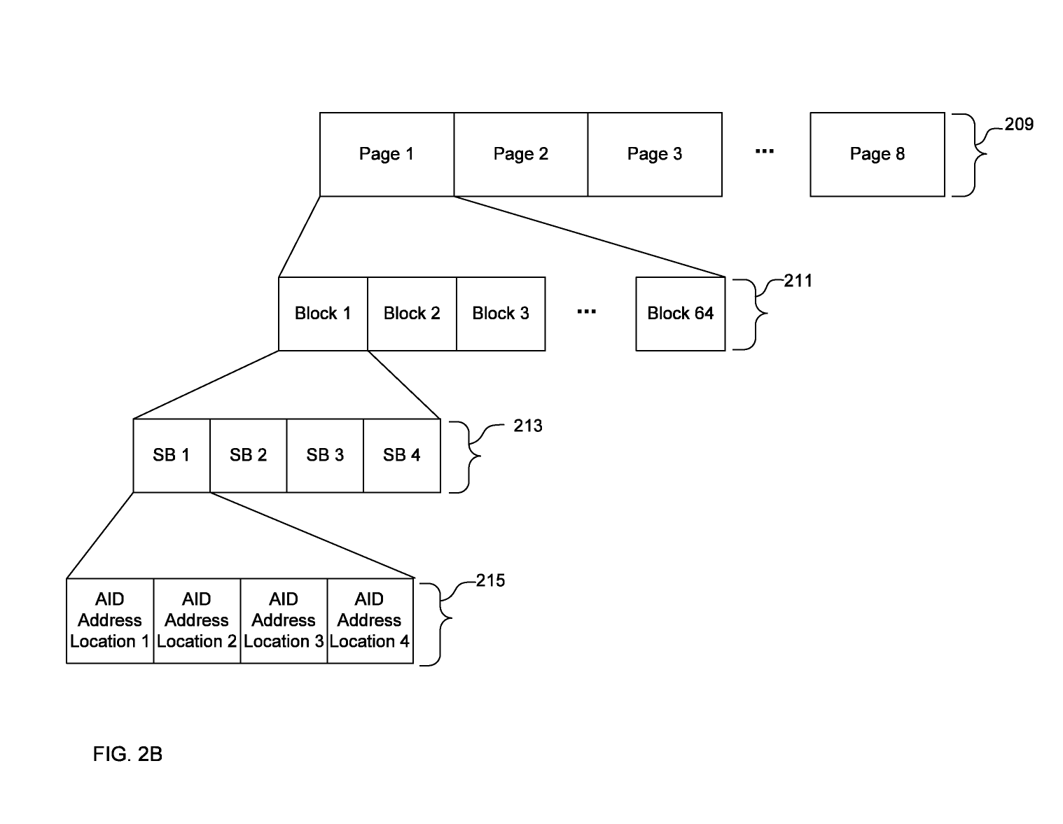

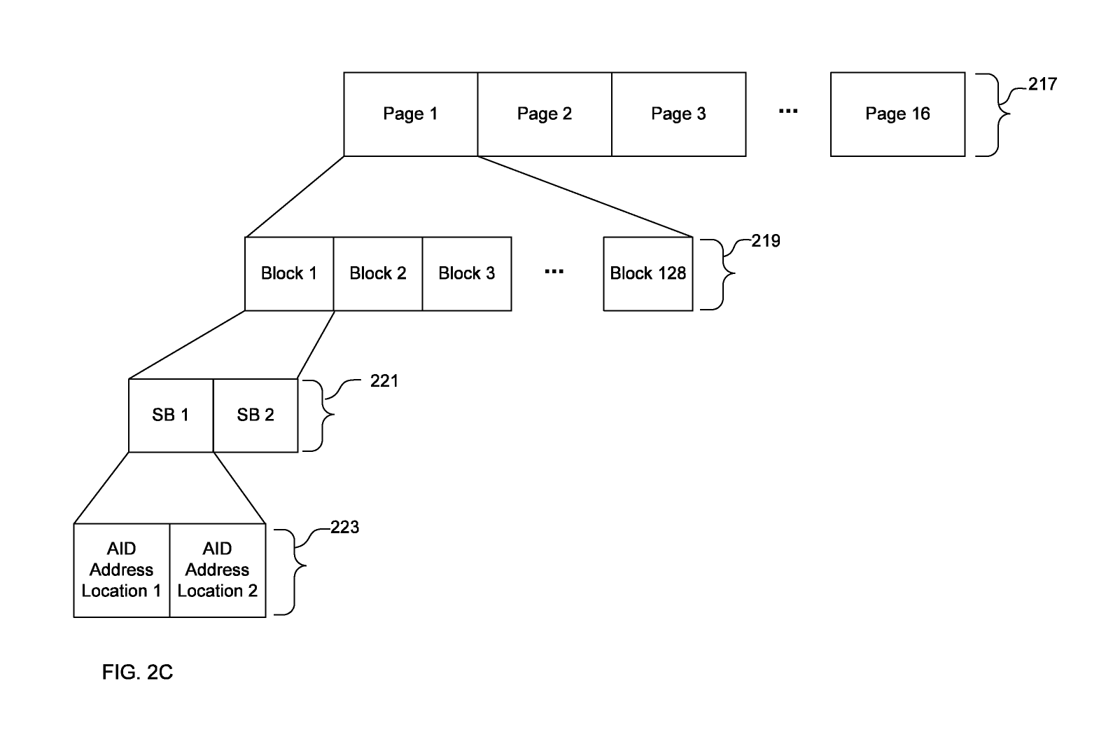

As one non-limiting example, with reference to FIG. 2A which shows a hierarchical addressing, according to at least one example embodiment, for the multiple mode AID addressing functionality discussed herein, hierarchy may be four pages (201) (e.g., corresponding to a 2 bit page index of a 13-bit AID), 32 blocks within each page (203) (e.g., corresponding to a 5 bit block offset and/or block index of a 13-bit AID), eight SBs within each block (205) (e.g., corresponding to a 3 bit SB offset and/or SB index of a 13-bit AID), and eight AID address locations (207) (e.g., corresponding to a 3 bit SB bitmap and/or STA bit position index bits of a 13-bit AID) in each SB, with each such AID address location corresponding to the AID of a STA. As is discussed in greater detail herein, optionally such an AID, considered in view of its corresponding AID address location, may correlate to a TWT.

As a second non-limiting example, with reference to FIG. 2B which shows a further hierarchical addressing, according to at least one example embodiment, for the multiple mode AID addressing functionality discussed herein, hierarchy may be eight pages (209) (e.g., corresponding to a 3 bit page index of a 13-bit AID), 64 blocks within each page (211) (e.g., corresponding to a 6 bit block offset and/or block index of a 13-bit AID), four SBs within each block (213) (e.g., corresponding to a 2 bit SB offset and/or SB index of a 13-bit AID), and four AID address locations (215) (e.g., corresponding to a 2 bit SB bitmap and/or STA bit position index bits of a 13-bit AID) in each SB, with each such AID address location corresponding to the AID of a STA. As is discussed in greater detail herein, optionally such an AID, considered in view of its corresponding AID address location, may correlate to a TWT.

As a third non-limiting example, with reference to FIG. 2C which shows an additional hierarchical addressing, according to at least one example embodiment, for the multiple mode AID addressing functionality discussed herein, hierarchy may be sixteen pages (217) (e.g., corresponding to a 4 bit page index of a 13-bit AID), 128 blocks within each page (219) (e.g., corresponding to a 7 bit block offset and/or block index of a 13-bit AID), two SBs within each block (221) (e.g., corresponding to a 1 bit SB offset and/or SB index of a 13-bit AID), and two AID address locations (223) (e.g., corresponding to a 1 bit SB bitmap and/or STA bit position index bits of a 13-bit AID) in each SB, with each such AID address location corresponding to the AID of a STA. As is discussed in greater detail herein, optionally such an AID, considered in view of its corresponding AID address location, may correlate to a TWT.

Additionally according to the illustrative example, the hierarchical addressing of FIG. 2A may correspond to a first AID addressing hierarchy mode, the hierarchical addressing of FIG. 2B may correspond to a second AID addressing hierarchy mode, and the hierarchical addressing of FIG. 2C may correspond to a third AID addressing hierarchy mode.

Further according to the illustrative example, AID addressing hierarchy mode indicators may be defined for AID addressing hierarchy modes. As a non-limiting example, such a mode indicator may be conveyed via the two most significant bits of an AID and/or via a 2-bit mode selection field of an AID. As a further non-limiting example, the bits “00” may convey the AID addressing hierarchy mode of FIG. 2A, the bits “01” may convey the AID addressing hierarchy mode of FIG. 2B, the bits “10” may convey the AID addressing hierarchy mode of FIG. 2C, and the bits “11” may be considered reserved. Further indication of addressing mode functionality is discussed hereinbelow.

The implementation of functionality discussed herein may yield a number of potential benefits including one or more of facilitating the grouping of STAs (e.g., TIM and/or non-TIM STAs) in view of hierarchical elements (e.g., grouping of STAs by page), allowing for a non-TIM STA to learn of its corresponding TWT without receiving explicit indication thereof from a corresponding AP during association, providing for the saving of some or all of the AP to STA data traffic corresponding to such explicit TWT indication, and employing an AID addressing hierarchy well-suited to an at-hand scenario (e.g., an at-hand scenario regarding STA grouping in view of hierarchical elements and/or an at-hand implicit target wake time assignment scenario well-suited for instance to maximizing compliance with STA requests for particular TWTs). As a non-limiting example, of a two octets for such data traffic, all two octets or a portion of those two octets (e.g., 1.5 octets) may be saved with such learning of TWT without receiving explicit indication thereof.

Still further according to the illustrative example, mode employment and/or change discussed herein may optionally occur and/or be indicated to STAs without implicit TWT assignment, without AID reassignment occurring with respect to those STAs, and/or with those STAs maintaining their AIDs. Such AID maintenance may, where mode change involves a change in AID length (e.g., from thirteen bits to fifteen bits) involve bit padding (e.g., with a STA employing padding to maintain its AID value in the face of change in specified AID length). Moreover, STAs discussed herein may optionally be TIM and/or non-TIM STAs (e.g., where mode change occurs and/or is indicated to STAs without implicit TWT assignment). Further, STAs discussed herein may optionally not be the subject of implicit TWT assignment.

### Multiple Mode Identifier Addressing—Implicit Target Wake Time Assignment, Non-Signaled Duration Functionality

Multiple mode identifier (e.g., AID) addressing, non-signaled duration implicit TWT assignment functionality according to at least one example embodiment will now be discussed. As discussed in greater detail herein, via such functionality a STA (e.g., a non-TIM station) receiving (e.g., during association) an AID, and in various embodiments an AID addressing hierarchy mode indicator (e.g., conveyed via AID bits), may be able to determine therefrom its TWT (e.g., stated as an offset relative to a TBTT), with the duration discussed herein perhaps being set and not being signaled (e.g., not being signaled during association). The STA may not receive explicit indication of its TWT, and as such may not receive explicit indication of its TWT during association. Optionally, the STA may specify to a corresponding AP (e.g., during association) one or more desired TWTs.

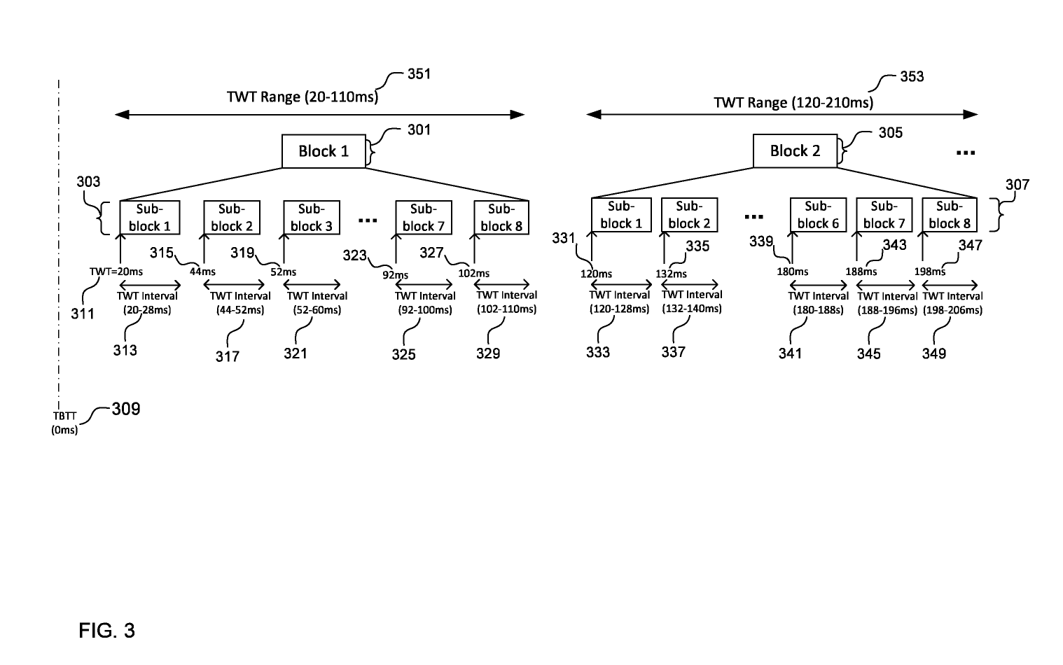

As an illustrative example of such functionality, with reference to FIG. 3, which shows TWT hierarchical addressing correspondence according to at least one example embodiment, within each block (301, 305), there may be eight SBs (303, 307) and within each such SB eight AID address locations. A TWT interval may be established for each SB. The TWT interval may specify a time span such that for each address location within that block there may be a corresponding TWT which sits within that time span.

Further according to the illustrative example, the spacing between such TWTs may be in accordance with a set duration. In connection with the non-signaled duration functionality now discussed, all such TWTs may be in accordance with the same set duration (e.g., 1 ms). Optionally, a TWT range may be established for each block. The TWT range for a block may span over the entire duration of the TWT intervals for the SBs of that block. The time span for each SB's interval may begin at an established initial value (e.g., stated in ms and/or as an offset relative to a TBTT) and may end at an end value which flows from that initial value, the number of AID address locations per corresponding SB, and the set duration. The value (e.g., in ms) for such a time span may flow from the number of AID address locations per corresponding SB and the set duration. As an example, such span may be 8 ms in the case of eight AID address locations per corresponding SB and a set duration of 1 ms. As noted, the TWT range for a block may span over the entire duration of the TWT intervals for the SBs of that block.

Still further according to the illustrative example, the first time value in a given TWT range for a block may be the initial value of the TWT interval of the first SB of that block, and the final time value in that TWT range may be the end value of the TWT interval of the last SB of that block. The value (e.g., in ms) of the time span for each block's range may flow from the number of SBs in that block, the number of AID address locations per each such SB, and the set duration. As an illustrative example, such block time span may be 64 ms in the case of eight SBs in the block, eight AID address locations per each SB, and a set duration of 1 ms.

Also according to the illustrative example, with further reference to FIG. 3 an example of a set duration of 1 ms is depicted. Within block 1 (301) may be its eight SBs, SB 1 through SB 8 (303). SB1 of block 1 (301) may have an initial value of 20 ms (311) and a TWT interval (313) which spans from 20-28 ms. SB 2 of block 1 (301) may have an initial value (315) of 44 ms and a TWT interval (317) which spans from 44-52 ms. SB 3 of block 1 (301) may have an initial value (319) of 52 ms and a TWT interval (321) which spans from 52-60 ms. SB 7 of block 1 (301) may have an initial value (323) of 92 ms and a TWT interval (325) which spans from 92-100 ms. SB 8 of block 1 (301) may have an initial value (327) of 102 ms and a TWT interval (329) which spans from 102-110 ms. TWT range (351) for block 1 (301) may span from 20-110 ms. In the foregoing, the values are stated as an offset relative to TBTT (309).

Additionally according to the illustrative example, with still further reference to FIG. 3 within block 2 (305) may be its eight SBs, SB 1 through SB 8 (307). SB1 of block 2 (305) may have an initial value of 120 ms (331) and a TWT interval (333) which spans from 120-128 ms. SB 2 of block 2 (305) may have an initial value (335) of 132 ms and a TWT interval (337) which spans from 132-140 ms. SB 6 of block 2 (305) may have an initial value (339) of 180 ms and a TWT interval (341) which spans from 180-188 ms. SB 7 of block 2 (305) may have an initial value (343) of 188 ms and a TWT interval (345) which spans from 188-196 ms. SB 8 of block 2 (305) may have an initial value (347) of 198 ms and a TWT interval (349) which spans from 198-206 ms. TWT range (353) for block 2 (305) may span from 120-210 ms. In the foregoing, the values are stated as an offset relative to TBTT (309).

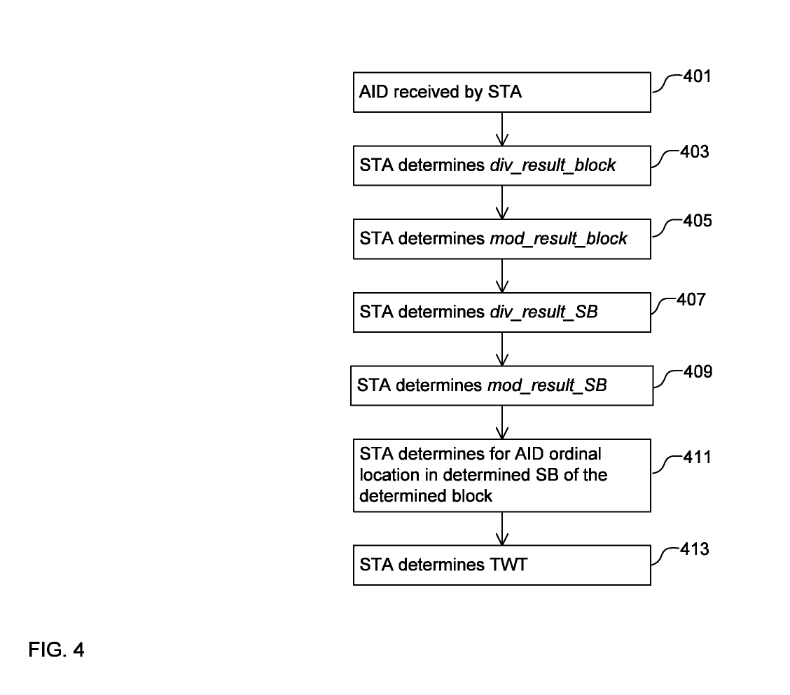

Further according to the illustrative example, with reference to FIG. 4, which shows an AID-TWT correlation calculation by a STA according to at least one example embodiment, a STA (e.g., a non-TIM STA) may learn from an AP during association an AID (e.g., an AID of 78, perhaps taken from the range 1-2007, from the range 1-2048, or from the range 1-8192) (401). In embodiments where the STA may receive an AID addressing hierarchy mode indicator (e.g., from the AP during association), the STA may use that mode indicator in order to select the appropriate corresponding AID addressing hierarchy. The STA (e.g., by virtue of knowing the corresponding AID addressing hierarchy) may be aware of the number of AID address locations per corresponding block (e.g., 64 AID address locations). The STA may then performs a DIV operation upon that AID and that number of AID address locations:

div_result_block=STA_AID DIV number_of_AID_per_block(403).

For a STA_AID of 78 and a number_of_AID_per_block of 64, such operation may yield a result of 1.

Additionally according to the illustrative example, the STA may perform a MOD operation upon that AID and that number of AID address locations:

mod_result_block=STA_AID MOD number_of_AID_per_block(405).

For a STA_AID of 78 and a number_of_AID_per_block of 64, such operation may yield a mod_result_block result of 14.

The STA (e.g., by virtue of knowing the corresponding AID addressing hierarchy) may be aware of the number of AID address locations per SB (e.g., 8). The STA may then performs a DIV operation upon mod_result_block and that number of AID address locations per SB:

div_result_SB=mod_result_block DIV number_of_AID_per_SB(407).

For a mod_result_block of 14 and a number_of_AID_per_SB of 8, such operation may yield a result of 1. The STA may then perform a MOD operation upon mod_result_block and number_of_AID_per_SB:

mod_result_SB=mod_result_block MOD number_of_AID_per_SB(409).

For a mod_result_block of 14 and a number_of_AID_per_SB of 8, such operation may yield a result of 6. From this the STA may know that its AID is the mod_result_SB-th AID in SB (div_result_SB+1) of block (div_result_block+1) (411).

For a mod_result_SB of 6, a div_result_SB of 1, and a div_result_block of 1, the STA may find itself to have the 6th AID in SB 2 of block 2.

Still further according to the illustrative example, the STA may determine its TWT (e.g., as an offset relative to a TBTT) as:

TWT=corresponding_initial_value+((mod_result_SB−1)*set_duration)(413).

Further according to the illustrative example, the STA may optionally after performing 411 check whether or not its AID is the first AID in the determined SB. Where the STA finds its AID to be the first AID in the determined SB, it may consider its TWT to be corresponding_initial_value and may not perform 413. Where the STA finds its AID to not be the first AID in the determined SB it may proceed to perform 413.

Still further according to the illustrative example, the STA may optionally perform AID-TWT correlation precalculation. Accordingly, rather than receiving a particular AID (e.g., during association) and then performing the above-discussed calculations with respect to that particular received AID, the STA may precalculate for each of one or more AID values taken from a pool of possible AID values the corresponding TWT. As such, the STA, with receipt of an AID, may be able to retrieve the corresponding precalculated TWT.

As to corresponding_initial_value and set_duration, the STA may be aware of the set duration and is aware of the initial value for the above-determined SB of the above-determined block. For the initial values discussed in connection with FIG. 3, such determined SB being 2 and such determined block being 2, the corresponding_initial_value is 132 ms. Further, for FIG. 3 the set duration is 1 ms. As such, for such a corresponding_initial_value of 132 ms, a mod_result_SB of 6, and a set duration of 1 ms, so calculating TWT may yield a result of 137 ms.

Additionally according to the illustrative example, with additional reference to FIG. 3, SB 1 of block 1 (301) may have a TWT interval (313) whose span ends at 28 ms while SB 2 of block 1 (301) may have a TWT interval (317) whose span starts at 44 ms, thus yielding a gap from 28 ms to 44 ms. In contrast, SB 2 of block 1 (301) may have a TWT interval (317) whose span ends at 52 ms while SB 3 of block 1 (301) may have a TWT interval (321) whose span starts at 52 ms, thus not yielding such a gap. As a non-limiting example, such gaps may reflect only one or more portions of the beacon period which commences with beacon period start (309) being used for non-TIM STAs, the balance of the beacon period perhaps being not used, or perhaps being used for other than non-TIM STAs. Examples of such non-TIM STA use may include use for TIM STAs having AIDs pulled from a different AID pool space (e.g., pulled from a different particular pool space of AIDs ranging from 1-2007, from 1-2048, or from 1-8192) than the non-TIM STAs whose AIDs indicate TWTs as discussed herein, and/or use for restricted access windows (RAWs).

Also according to the illustrative example, as a further non-limiting example, where non-TIM STAs whose AIDs indicate TWTs as discussed herein and TIM STAs have AIDs pulled from the same AID pool space, certain pages, blocks, and/or corresponding AID address hierarchy may be designated for such non-TIM STAs and other pages, blocks, and/or SBs of that AID address hierarchy may be designated for such TIM STAs. As such some AIDs from the corresponding pool (e.g., a pool of AIDs ranging from 1-2007 from 1-2048, or from 1-8192) may be given to such non-TIM STAs and other AIDs from that pool may be given to such TIM STAs. AID-TWT correlation may reflect this. As a particular example, a nth SB (e.g., a SB 1) may have a TWT interval which ends at x ms (e.g., 16 ms) and a (n+2)th SB (e.g., a SB 3) may have a TWT interval which starts at that same x ms (e.g., 16 ms) reflecting the nth SB (e.g., SB 1) and the (n+2)th SB (e.g., SB 3) perhaps being for non-TIM STAs and the (n+1)th SB (e.g., SB 2) perhaps being for TIM STAs.

Further according to the illustrative example, it is noted that the discussed calculations by which a STA determines the TWT which correlates to its AID may be compatible with circumstances wherein AID-TWT correlation may not be a linear one within an element (e.g., within a page or block). The presence of such linearity may be evidenced by the TWT for a given AID perhaps being determinable by solving an equation in the form of TWT=AID+X, where X a commencement value (e.g., where X represents that start of an appropriate TWT range). Such lack of linear correlation may arise in situations including those discussed above concerning TIM STAs and non-TIM STAs having AIDs pulled from the same AID pool space, and TIM and non-TIM STAs having AIDs pulled from different AID pool spaces.

Still further according to the illustrative example, it is noted that the AID-TWT calculation discussed above calculated, for an AID of 48, a corresponding TWT (e.g., with TWT being expressed as an offset relative to a TBTT) of 137 ms, a value which correctly takes into account the discussed gaps depicted in FIG. 3. In contrast, an attempt at a pure linear calculation of the TWT (e.g., with TWT being expressed as an offset relative to a TBTT) corresponding to the AID of 78 might prove incompatible with the discussed gaps depicted in FIG. 3. To with, such a pure linear calculation might involve calculating TWT (e.g., with TWT being expressed as an offset relative to a TBTT) as:

TWT=start_of_range_for_first_block+((AID−1)*set_duration)

With an eye towards FIG. 3, start_of_range_for_first_block is 20 ms, set_duration is 1 ms, and as referenced AID is 78, thus yielding a result of TWT=97 ms rather than the correct value of 137 ms which results from calculation appropriately compatible with the discussed gaps of FIG. 3.

Furthermore according to the illustrative example, it is noted that FIG. 3 and FIG. 4, and the text corresponding thereto, as set forth herein are from the vantage point of a given page of the corresponding AID addressing hierarchy, such that block 1 (301) and block 2 (305) are two blocks (e.g., the first two blocks) of that given page. A STA in receipt of an AID, as one non-limiting example, may know the page at which the AID sits within the corresponding AID addressing hierarchy by direct consideration of the AID itself. As an example, AID values may not reset with a new page and instead may run increasingly in value from the first block of the first page to the last block of the last page. As such, the AID value may indicate the page in which it sits. As a non-limiting illustration, where AIDs run from 1-8192 and there are four pages, AIDs 1-2048 may fall within the first page, AIDs 2049-4096 may fall within the second page, AIDs 4097-6144 may fall within the third page, and AIDs 6145-8192 may fall within the fourth page.

As a second non-limiting example, a STA in receipt of an AID may know the page at which the AID sits by other than direct consideration of the AID itself. For instance, the STA may be aware that the AIDs which it receives all fall within one or more specified pages (e.g., stemming from an AID addressing organization which, say, groups STAs according to type in a pagewise fashion). Circumstances to which the functionality of the second non-limiting example are applicable may include both circumstances where AID values do reset with a new page and circumstances where AIDs run increasingly in value from the first block of the first page to the last block of the last page.

Additionally according to the illustrative example, as discussed a STA may perform calculations in order to determine the TWT (e.g., expressed as an offset relative to a TBTT) which correlates with its received AID. The STA may awaken at its TWT to dispatch buffered data to and/or receive buffered data from its AP. The AP may likewise be capable of determining, for each of one or more of its STAs, the TWT (e.g., expressed as an offset relative to a TBTT) that correlates with the AID of that STA. Such determination by the AP may yield a number of potential benefits including being able to know when to expect exchange of buffered data with a given STA. As a non-limiting example, the AP may not be aware of the TWT of such a STA prior to such determination.

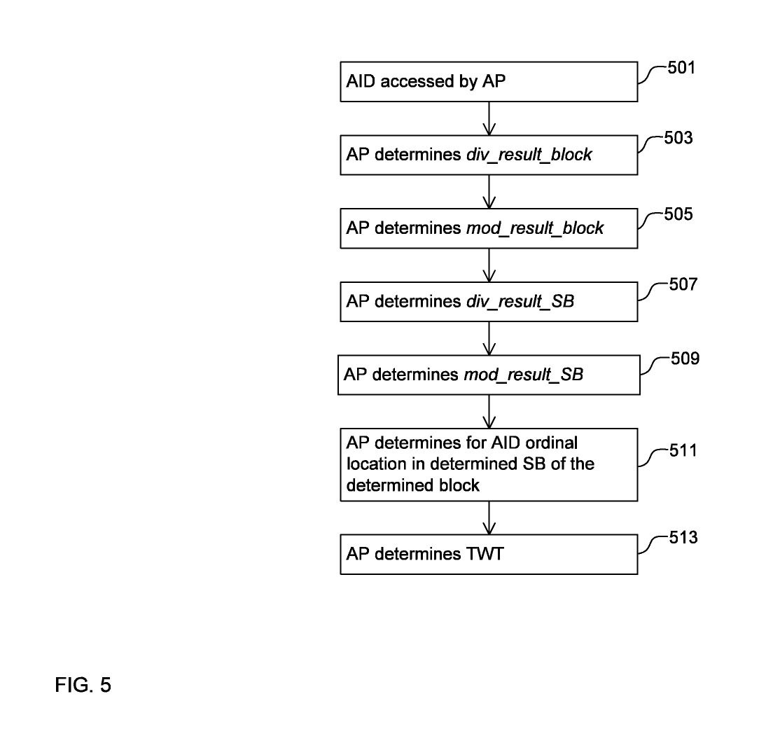

Also according to the illustrative example, such an AP may calculate such AID-TWT correlation in a manner analogous to the non-signaled duration AID-TWT correlation calculations discussed above as being performed by a STA. In embodiments where there is more than one AID addressing hierarchy, the AP may perform the calculations with respect to an appropriate particular AID addressing hierarchy (e.g., corresponding to an AID addressing hierarchy mode with respect to which the AP is to determine an AID-TWT correlation). As such, with reference to FIG. 5 which shows an AID-TWT correlation calculation by an AP according to at least one example embodiment, the AP may access (e.g., from a storage location) the AID corresponding to the STA with respect to which TWT is to be determined (501). Next, the AP may determine div_result_block (503) in a manner analogous to that discussed above in connection with FIG. 4, determine mod_result_block (505) in a manner analogous to that discussed above in connection with FIG. 4, determine div_result_SB (507) in a manner analogous to that discussed above in connection with FIG. 4, determine mod_result_SB (509) in a manner analogous to that discussed above in connection with FIG. 4, determine for the appropriate AID the ordinal location in the determined SB of the determined block (511) in a manner analogous to that discussed above in connection with FIG. 4, and determine the TWT (513) in a manner analogous to that discussed above in connection with FIG. 4.

Also according to the illustrative example, optionally after performing 511 the AP may act in a manner analogous to that discussed above in connection with FIG. 4 with regard to checking whether or not an AID is the first AID in a determined SB.

Additionally according to the illustrative example, the AP may optionally perform AID-TWT correlation precalculation in a manner analogous to that discussed above. As such, the AP, perhaps assigning an AID to a particular STA and/or informing a particular STA of its AID, may be able to retrieve the corresponding precalculated TWT.

Further according to the illustrative example, a STA, from an AP during association, may learn of its AID. The STA may additionally be aware of information including the pages or pages within which its received AIDs fall, the number of AID address locations per block, the number of AID address locations per SB, the AID addressing hierarchy, the initial values of intervals, and/or of the set duration at hand. Examples of modes of awareness of such information may include one or more of receipt from a corresponding AP and/or server (e.g., at association and/or at one or more times other than association), incorporation into STA program code and/or data stores (e.g., wherein the STA is provided with such information during manufacture, software install, and/or software upgrade), entry by an individual (e.g., by a STA user and/or by a system administrator), and awareness due to other information (e.g., awareness due to knowledge of a corresponding AID addressing hierarchy).

Still further according to the illustrative example, aspects including one or more of the assignment of AIDs to STAs, the number of AID address locations per block, the number of AID address locations per SB, the AID addressing hierarchy, the initial values of intervals, and the set duration may be defined in a number of ways including definition by an individual (e.g., by an AP user and/or by a system administrator), definition (e.g., performed at a time prior to a corresponding AID-TWT correlation calculation discussed herein) by a manufacturer, and/or automated definition (e.g., with an AP defining one or more of such values to meet resource scheduling, power saving, and/or other goals). As the AID-TWT correlation calculations discussed herein may take into account various of these aspects, such aspect definition may serve to define AID-TWT correlation. As a non-limiting example, by defining one or more of AID to STA assignment, the initial values of intervals, and set duration, such an individual, manufacturer, and/or automated definition may act to define AID-TWT correlation.

Also according to the illustrative example, it is noted that a STA (e.g., a non-TIM STA) may conventionally learn explicitly of its TWT during association with an AP via a dispatch of data (e.g., data being two octets in length), from the AP to the STA, which may specify that TWT. In connection with the above-discussed implicit target wake time assignment non-signaled duration functionality, the STA may not receive such explicit TWT indication and instead may determine the TWT using the above-discussed received AID. As such, and taking into account that such above-discussed implicit target wake time assignment non-signaled duration functionality may not call for the above-discussed duration to be signaled to the STA, the entirety of the data corresponding to conventional TWT dispatch (e.g., the entire two octets) may be saved, thus yielding potential benefits including power saving.

Still further according to the illustrative example, mode employment and/or change discussed herein may optionally occur and/or be indicated to STAs without implicit TWT assignment, without AID reassignment occurring with respect to those STAs, and/or with those STAs maintaining their AIDs. Such AID maintenance may, where mode change involves a change in AID length (e.g., from thirteen bits to fifteen bits) involve bit padding (e.g., with a STA employing padding to maintain its AID value in the face of change in specified AID length). Moreover, STAs discussed herein may optionally be TIM and/or non-TIM STAs (e.g., where mode change occurs and/or is indicated to STAs without implicit TWT assignment). Further, STAs discussed herein may optionally not be the subject of implicit TWT assignment.

### Multiple Mode Identifier Addressing—Implicit Target Wake Time Assignment, Signaled Duration Functionality

Multiple mode identifier (e.g., AID) addressing, signaled duration implicit TWT assignment functionality according to at least one example embodiment will now be discussed. As discussed in greater detail herein, via such functionality a STA (e.g., a non-TIM station) receiving (e.g., during association) an AID, a discussed-herein duration, and in various embodiments an AID addressing hierarchy mode indicator (e.g., conveyed via AID bits) may be able to determine therefrom its TWT (e.g., stated as an offset relative to a TBTT). The STA may not receive explicit indication of its TWT, and as such does may not receive explicit indication of its TWT during association. Optionally, the STA may specify to a corresponding AP (e.g., during association) one or more desired TWTs.

As an illustrative example of such functionality, an alteration of the above-discussed implicit target wake time assignment non-signaled duration functionality may allow for STA determination of TWT in the absence of explicit TWT indication under the circumstance where duration may vary on, for instance, a per-SB basis. As a non-limiting example, suppose the duration for a first SB being 1 ms and the duration for a second SB being 2 ms, thus being in contrast to the example described in connection with non-signaled functionality wherein the same 1 ms duration applied to all SBs.

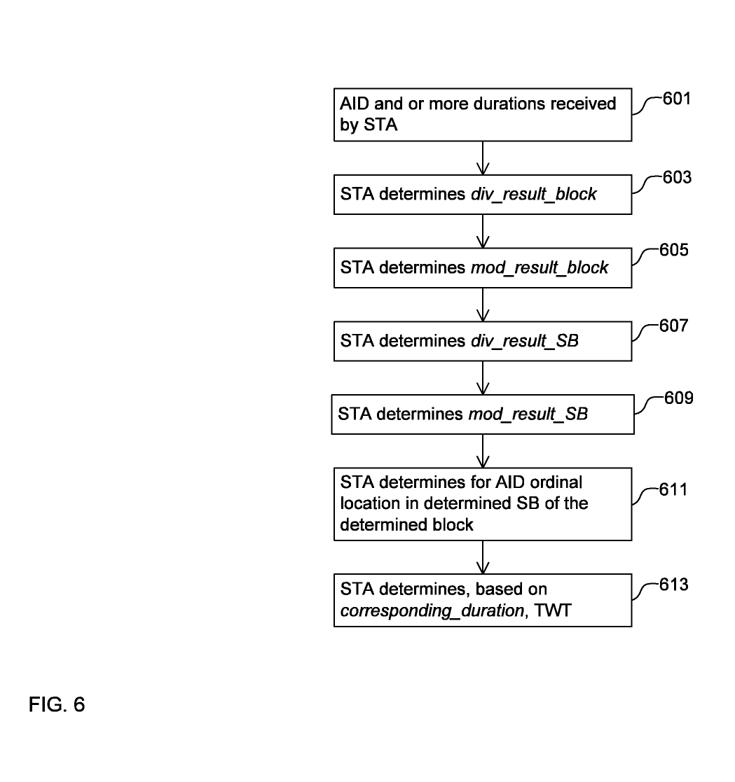

Further according to the illustrative example, with reference to FIG. 6 which shows a further AID-TWT correlation calculation by a STA according to at least one example embodiment, the STA may act in a manner generally analogous to that discussed in connection with 401, but may learn from an AP during association not just an AID, and in various embodiments an AID addressing hierarchy mode indicator, but also one or more durations for one or more SBs (601). In embodiments where the STA receives an AID addressing hierarchy mode indicator (e.g., from the AP during association), the STA may use that mode indicator in order to select the appropriate corresponding AID addressing hierarchy. Optionally, the STA may only receive the duration for the SB within which its AID is situated. The STA may then determine div_result_block (603) in a manner analogous to that discussed above in connection with 403, determine mod_result_block (605) in a manner analogous to that discussed above in connection with 405, determine div_result_SB (607) in a manner analogous to that discussed above in connection with 407, determine mod_result_SB (609) in a manner analogous to that discussed above in connection with 409, and determine for the appropriate AID the ordinal location in the determined SB of the determined block (611) in a manner analogous to the discussed above in connection with 411.

Still further according to the illustrative example, the STA may then determine the TWT in a manner generally analogous to that discussed above in connection with 413, but perhaps employing in place of set_duration of 413 corresponding_duration, where corresponding_duration is the duration for the 609-determined SB of the 609-determined block (613). As such the STA may calculate its TWT (e.g., as an offset relative to a TBTT) as:

TWT=corresponding_initial_value+((mod_result_SB−1)* corresponding_duration).

Additionally according to the illustrative example, returning to the example of FIG. 4 but now employing corresponding_duration and taking the value thereof to be 3 ms for the determined SB of the determined block, taking mod_result_SB to be 6 in connection with the corresponding performance of 609, and taking corresponding_initial_value to remain as 132 ms, and as such not to have been affected by duration differences, yields a result of 147 ms.

Also according to the illustrative example, optionally after performing 611 the STA may act in a manner analogous to that discussed above in connection with FIG. 4 with regard to checking whether or not an AID is the first AID in a determined SB.

Further according to the illustrative example, the STA may optionally perform AID-TWT precalculation in a manner analogous to that discussed above. As a non-limiting example, the STA may be aware of the duration which would apply to a given AID and may employ that duration value in precalculation. As another non-limiting example, the STA may perform such precalculation for a given AID with respect to a plurality of possible durations for that AID.

Also according to the illustrative example, as discussed a STA may be capable of performing calculations in order to determine the TWT (e.g., expressed as an offset relative to a TBTT) which correlates with its received AID and further taking into account a received duration. The AP may likewise be capable of determining, for one or more of its STAs, the TWT the correlates with the AID for that STA and with the appropriate corresponding duration.

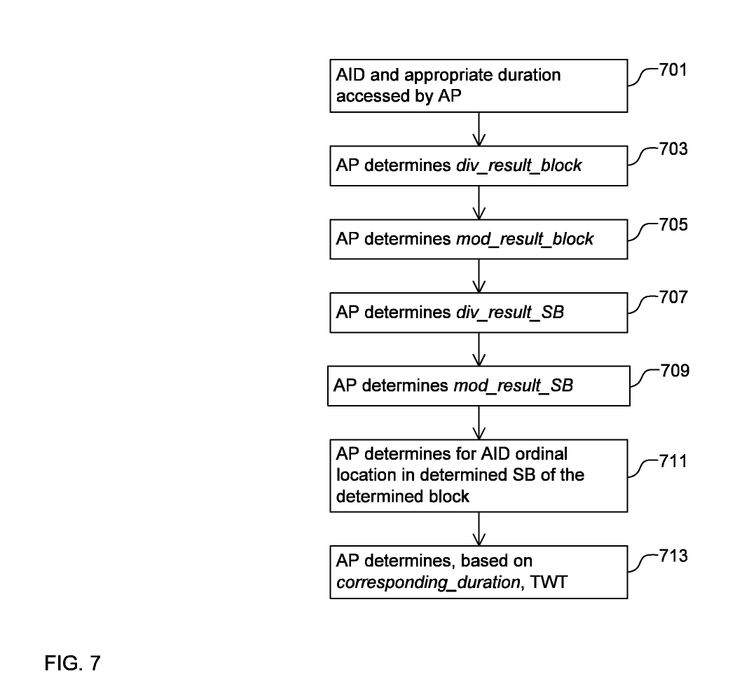

Further according to the illustrative example, such AP may calculate such AID-TWT correlation in a manner analogous to the signaled duration AID-TWT correlation calculations discussed herein as being performed by a STA. In embodiments where there is more than one AID addressing hierarchy, the AP may perform the calculations with respect to an appropriate particular AID addressing hierarchy (e.g., corresponding to an AID addressing hierarchy mode with respect to which the AP is to determine an AID-TWT correlation). As such, with respect to FIG. 7 which shows a further AID-TWT correlation calculation by an AP according to at least one example embodiment, for each of one or more of its STAs the AP may access (e.g., from a storage location) the AID and appropriate duration corresponding to the STA with respect to which TWT is to be determined (701). Next, the AP may determine div_result_block (703) in a manner analogous to that discussed above in connection with FIG. 6, determine mod_result_block (705) in a manner analogous to that discussed above in connection with FIG. 6, determine div_result_SB (707) in a manner analogous to that discussed above in connection with FIG. 6, determine mod_result_SB (709) in a manner analogous to that discussed above in connection with FIG. 6, determine for the AID the ordinal location in the determined SB of the determined block (711) in a manner analogous to that discussed above in connection with FIG. 6, and determine, based on corresponding_duration, the TWT (713) in a manner analogous to that discussed above in connection with FIG. 6. The AP may optionally act in a manner analogous to that discussed above with regard to checking whether or not an AID is the first AID in a determined SB. The AP may optionally perform AID-TWT precalculation in a manner analogous to that discussed above. As a non-limiting example, the AP may be aware of the duration which would apply to a given AID and may employ that duration in precalculation. As another non-limiting example, the AP may performs such precalculation for a given AID with respect to a plurality of possible durations for that AID.

Also according to the illustrative example, it is noted that a STA (e.g., a non-TIM STA) may conventionally learns explicitly of its TWT during association with an AP via a dispatch of data (e.g., data being two octets in length), from the AP to the STA, which specifies that T. In connection with the above-discussed implicit target wake time assignment signaled duration functionality, the STA may not receive such explicit TWT indication and instead may determine the TWT using the above-discussed received AID and the above-discussed received duration. As such, and taking into account that such above-discussed implicit target wake time assignment signaled duration functionality calls for the duration to be signaled to the STA (e.g., requiring half an octet), a portion of the data corresponding to conventional TWT dispatch (e.g., a portion of the two octets) may be saved, thus yielding potential benefits including power saving. As a non-limiting example, in the case where conventional TWT dispatch requires two octets and duration signaling requires half an octet, 1.5 octets may be saved relative to conventional functionality.

Still further according to the illustrative example, mode employment and/or change discussed herein may optionally occur and/or be indicated to STAs without implicit TWT assignment, without AID reassignment occurring with respect to those STAs, and/or with those STAs maintaining their AIDs. Such AID maintenance may, where mode change involves a change in AID length (e.g., from thirteen bits to fifteen bits) involve bit padding (e.g., with a STA employing padding to maintain its AID value in the face of change in specified AID length). Moreover, STAs discussed herein may optionally be TIM and/or non-TIM STAs (e.g., where mode change occurs and/or is indicated to STAs without implicit TWT assignment). Further, STAs discussed herein may optionally not be the subject of implicit TWT assignment.

### Multiple Mode Identifier Addressing—Implicit Target Wake Time Assignment, Target Wake Time Management and Identifier Addressing Hierarchy Mode Selection Functionality

Multiple mode identifier (e.g., AID) addressing, TWT management and corresponding identifier (e.g., AID) addressing hierarchy mode selection functionality according to at least one example embodiment will now be discussed. As discussed in greater detail herein, via such functionality an AP may perform implicit TWT assignment and/or reassignment, and may evaluate which AID addressing hierarchy mode may allow the AP to best satisfy one or more STAs with respect to TWTs (e.g., where the AP is already employing a particular AID addressing hierarchy mode, the AP may consider whether a change in AID addressing hierarchy mode might allow the AP to better satisfy one or more STAs with respect to TWTs). In performing such evaluation the AP may consider factors including STA indications of desired TWT (e.g., provided during association) and/or TWTs already assigned to STAs.

As an illustrative example of such functionality, association between an AP (e.g., an AP already employing a particular AID addressing hierarchy mode) and a STA may commence (e.g., including the STA sending an association request to the AP). The STA may optionally specify one or more desired TWTs. Where the STA specifies one or more desired TWTs, the AP may determine which, if any, of those desired TWTs remain unassigned to any already-associated STAs. The AP may consult one or more stores (e.g., one or more local and/or remote stores) wherein the AP keeps track of STA-TWT assignments and may determine whether or not any of the STA's desired TWTs are available. Where none of the desired TWTs are available, the AP may instead consider the closest in value unassigned TWT.

Also according to the illustrative example, the AP may then perform a best AID addressing hierarchy mode determination with respect to one or more of such TWTs found to remain unassigned. As a non-limiting example, the AP may perform a best AID addressing hierarchy mode determination with respect to each of such TWTs found to remain unassigned. Where the STA suggests more than one desired TWT, and the AP finds, by performing best AID addressing hierarchy mode determination operations, that employment certain of those TWTs may lead to an AID addressing hierarchy mode change while employment of others of such TWTs may not lead to an addressing mode change, the AP may optionally choose one of the TWTs which would not lead to an addressing mode change. Moreover, where the STA suggests more than one desired TWT and also corresponding preference rankings, the AP may optionally take such rankings into account in selecting a TWT to assign to the STA (e.g., the AP may select the most preferred unassigned TWT).

Further according to the illustrative example, where the STA does not suggest any desired TWTs, the AP may choose one for the STA which remains unassigned and/or which may not lead to an addressing mode change.

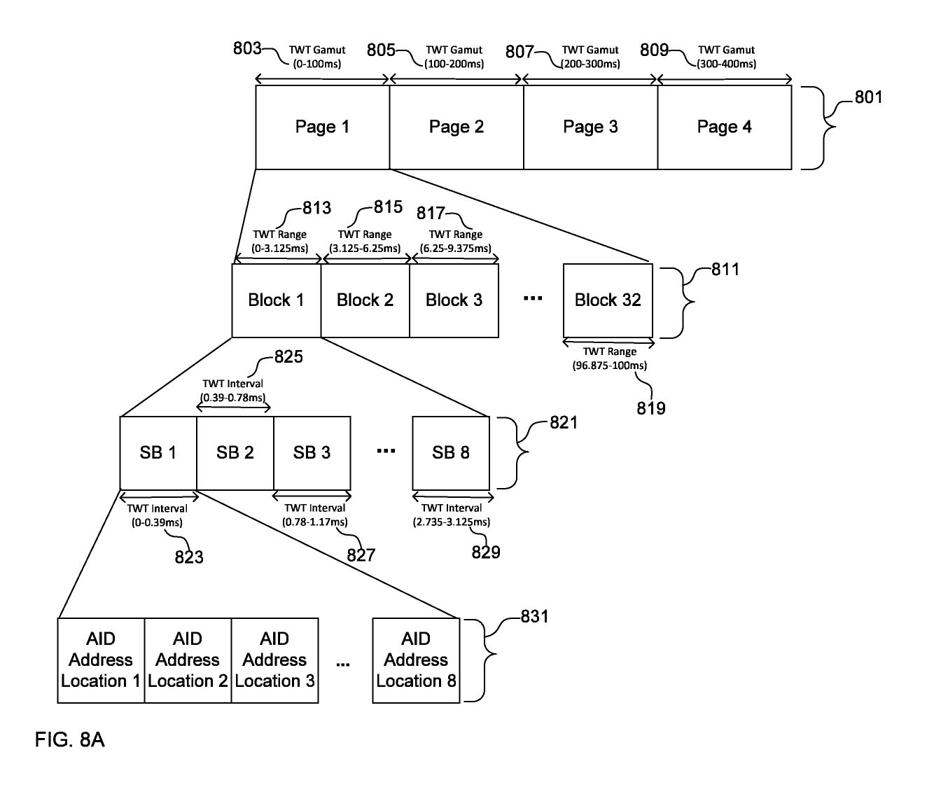

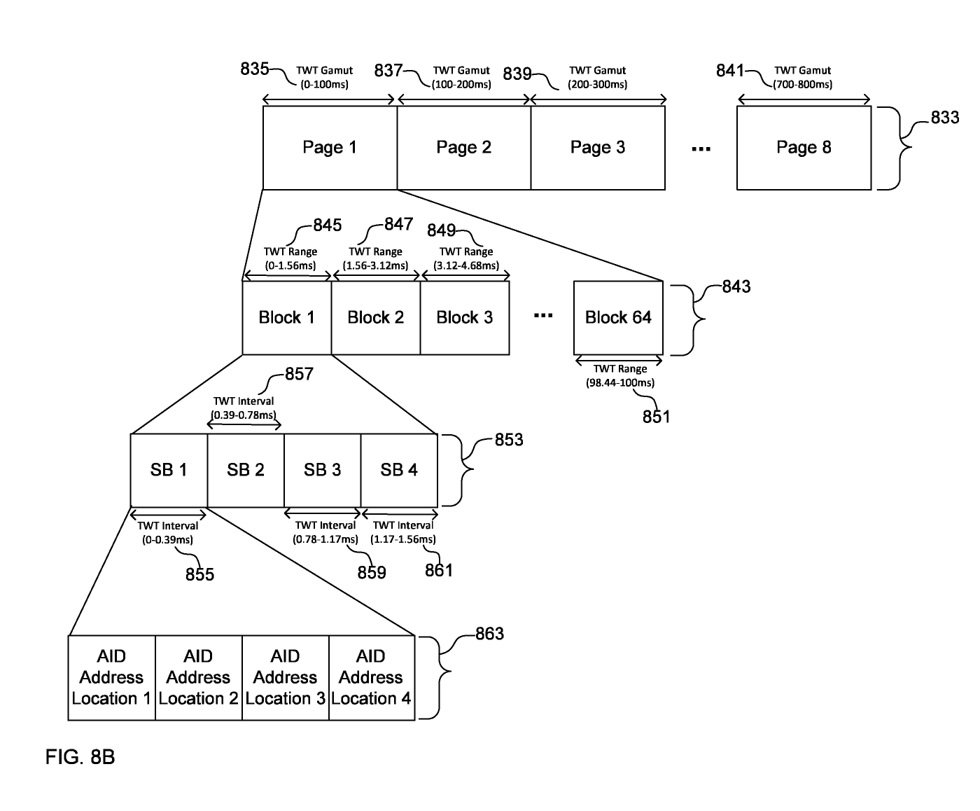

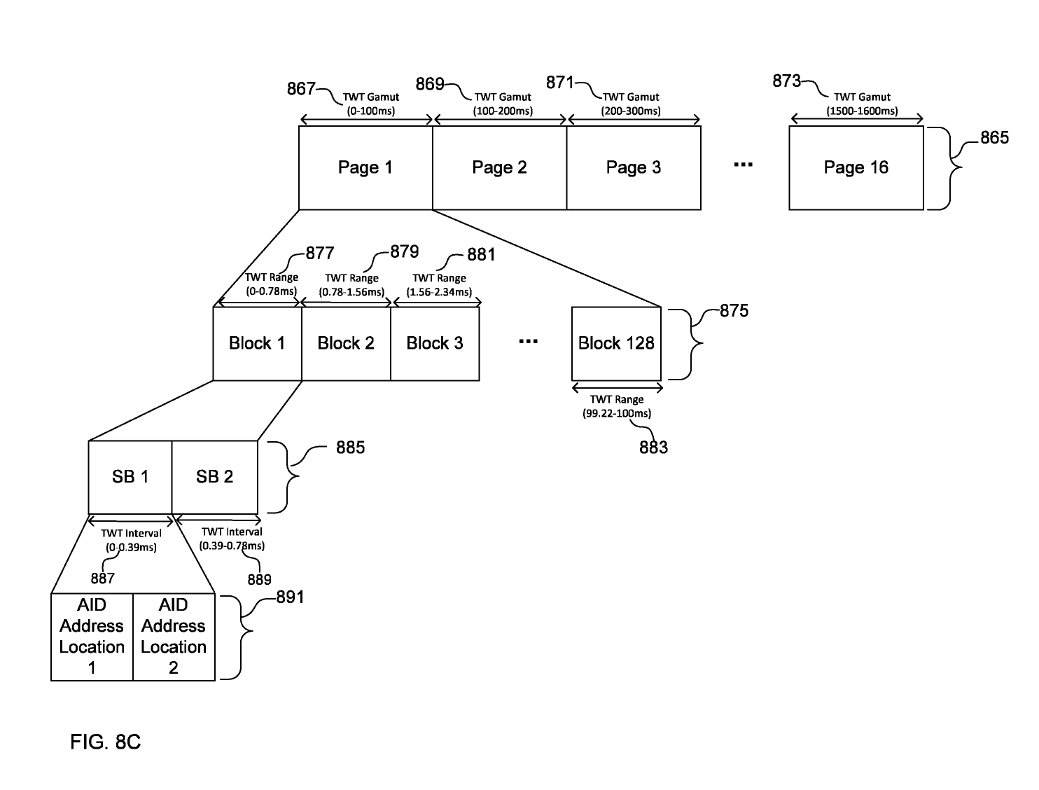

Still further according to the illustrative example, shown in FIGS. 8A-8C are three TWT hierarchical addressing correspondences in accordance with at least one example embodiment. The TWT hierarchical addressing correspondences of FIGS. 8A-8C apply respectively to the AID addressing hierarchy modes of FIGS. 2A-2C.

Also according to the illustrative example, the four pages (801) of FIG. 8A are page 1 through page 4. Page 1 may have a TWT gamut (803) which spans from 0-100 ms, page 2 may have a TWT gamut (805) which spans from 100-200 ms, page 3 may have a TWT gamut (807) which spans from 200-300 ms, and page 4 may have a TWT gamut (809) which spans from 300-400 ms. Pages 1-4 may each include 32 blocks. Depicted in FIG. 8A are the 32 blocks of page 1 (811), with blocks 1-3 and 32 thereof being explicitly shown, and blocks 4-31 thereof being conveyed via an ellipsis. Block 1 of page 1 may have a TWT range (813) which spans from 0-3.125 ms, block 2 of page 1 may have a TWT range (815) which spans from 3.125-6.25 ms, block 3 of page 1 may have a TWT range (817) which spans from 6.25 to 9.375 ms, and block 32 of page 1 may have a TWT range which spans from 96.875-100 ms. Blocks 4-31, which are conveyed via an ellipsis, each have a TWT range which is 3.125 ms wide, the particular spans of each being such so as to appropriately fill the time space starting at 9.375 ms and ending at 96.875 ms.

Additionally according to the illustrative example, Blocks 1-32 each may include eight SBs. Depicted in FIG. 8A are the 8 SBs of block 1 (821), with SBs 1-3 and 8 thereof being explicitly shown, and SBs 4-7 thereof being conveyed via an ellipsis. SB 1 of block 1 may have a TWT interval (823) which spans from 0-0.39 ms, SB 2 of block 1 may have a TWT interval (825) which spans from 0.39-0.78 ms, SB 3 of block 1 may have a TWT interval (827) which spans from 0.78-1.17 ms, and SB 8 of block 1 may have a TWT interval which spans from 2.735 ms to 3.125 ms. SBs 4-7, which are conveyed via an ellipsis, each have a TWT interval which is 0.39 ms wide, the particular spans of each being such as to appropriately fill the time space starting at 1.17 ms and ending at 2.735 ms.

Further according to the illustrative example, SBs 1-8 may each include eight AID address locations. Depicted in FIG. 8A are the eight AID address locations of SB 1 (831), which AID address locations 1-3 and 8 thereof being explicitly shown, and AID address locations 4-7 being conveyed via en ellipsis.

Still further according to the illustrative example, the eight pages (833) of FIG. 8B may be page 1-8, with pages 1-3 and 8 being explicitly shown, and pages 4-7 being conveyed via an ellipsis. Page 1 may have a TWT gamut (835) which spans from 0-100 ms, page 2 may have a TWT gamut (837) which spans from 100-200 ms, page 3 may have a TWT gamut (839) which spans from 200-300 ms, and page 8 may have a TWT gamut (841) which spans from 700-800 ms. Pages 4-7, which are conveyed via an ellipsis, each have a TWT gamut which is 100 ms wide, the particular spans of each being such as to appropriately fill the time space starting at 300 ms and ending at 700 ms.

Additionally according to the illustrative example, pages 1-8 each may include 64 blocks. Depicted in FIG. 8B are the 64 blocks of page 1 (843), with blocks 1-3 and 64 thereof being explicitly shown, and blocks 4-63 thereof being conveyed via an ellipsis. Block 1 of page 1 may have a TWT range (845) which spans from 0-1.56 ms, block 2 of page 1 may have a TWT range (847) which spans from 1.56-3.12 ms, block 3 of page 1 may have a TWT range (849) which spans from 3.12-4.68 ms, and block 64 of page 1 may have a TWT range (851) which spans from 98.44-100 ms. Blocks 4-63, which are conveyed via an ellipsis, each have a TWT range which is 1.56 ms wide, the particular spans of each being so as to appropriately fill the time space starting at 4.68 ms and ending at 98.44 ms.

Also according to the illustrative example, blocks 1-64 each may include four SBs. Depicted in FIG. 8B are the four SBs of block 1 (853). SB 1 of block 1 may have a TWT interval (855) which spans from 0-0.39 ms, SB 2 of block 1 may have a TWT interval (857) which spans from 0.39-0.78 ms, SB 3 of block 1 may have a TWT interval (859) which spans from 0.78-1.17 ms, and SB 4 of block 1 may have a TWT interval (861) which spans from 1.17-1.56 ms. SBs 1-4 each include four AID address locations. Depicted in FIG. 8B are the four AID address locations of SB 1 (863).

Further according to the illustrative example, the sixteen pages (865) of FIG. 8C are page 1-16, with pages 1-3 and 16 being explicitly shown, and pages 4-15 being conveyed via an ellipsis. Page 1 may have a TWT gamut (867) which spans from 0-100 ms, page 2 may have a TWT gamut (869) which spans from 100-200 ms, page 3 may have a TWT gamut (871) which spans from 200-300 ms, and page 16 may have a TWT gamut (873) which spans from 1500-1600 ms. Pages 4-15, which are conveyed via an ellipsis, each have a TWT gamut which is 100 ms wide, the particular spans of each being such as to appropriately fill the time space starting at 300 ms and ending at 1500 ms.

Still further according to the illustrative example, pages 1-16 each include 128 blocks. Depicted in FIG. 8C are the 128 blocks of page 1 (875), with blocks 1-3 and 128 thereof being explicitly shown, and blocks 4-127 thereof being conveyed via an ellipsis. Block 1 of page 1 may have a TWT range (877) which spans from 0-0.78 ms, block 2 of page 1 may have a TWT range (879) which spans from 0.78-1.56 ms, block 3 of page 1 may have a TWT range (881) which spans from 1.56-2.34 ms, and block 128 of page 1 may have a TWT range (883) which spans from 99.22-100 ms. Blocks 4-127, which are conveyed via an ellipsis, each have a TWT range which is 0.78 ms wide, the particular spans of each being so as to appropriately fill the time space starting at 2.34 ms and ending at 99.22 ms.

Additionally according to the illustrative example, blocks 1-128 may each include two SBs. Depicted in FIG. 8C are the two SBs of block 1 (885). SB 1 of block 1 may have a TWT interval (887) which spans from 0-0.39 ms. SB 2 of block 1 may have a TWT interval (889) which spans from 0.39-0.78 ms. SBs 1 and 2 may each include two AID address locations. Depicted in FIG. 8C are the two AID address locations of SB 1 (891).

Also according to the illustrative example, factors considered by the AP in evaluating the AID addressing hierarchy mode to be employed may include STA indications of desired TWTs and/or TWTs already assigned to STAs. As such, as a non-limiting example the AP in considering the TWT hierarchical addressing correspondences of FIGS. 8A-8C relative to one another in one aspect may discover that the hierarchical addressing correspondence of FIG. 8A, by virtue of having eight AID address locations for SB 1 of block 1 of page 1, allows eight STAs to have TWTs within the TWT time span 0-0.39 ms, but, by virtue of having merely four 100 ms wide pages, limits STAs to having TWTs within the time span 0-400 ms.

Further according to the illustrative example, in considering the TWT hierarchical addressing correspondences of FIGS. 8A-8C relative to one another the AP in a second aspect may discover that the hierarchical addressing correspondence of FIG. 8B, by virtue of having four AID address locations for SB 1 of block 1 of page 1, allows four STAs to have TWTs within the time span 0-0.39 ms—therefore only half the number of STAs which the hierarchical addressing correspondence of FIG. 8A was able to accommodate within that time span. On the other hand, the hierarchical addressing correspondence of FIG. 8B, by virtue of having eight 100 ms wide pages, may allow STAs to have TWTs within a time span of 0-800 ms, outstripping the 0-400 ms span provided for by the hierarchical addressing correspondence of FIG. 8A.

Still further according to the illustrative example, in considering the TWT hierarchical addressing correspondences of FIGS. 8A-8C relative to one another the AP in a third aspect may discover that the hierarchical addressing correspondence of FIG. 8C, by virtue of having two AID address locations for SB 1 of block 1 of page 1, allows only two STAs to have TWTs within the time span 0-0.39 ms—therefore only half the number of STAs which the hierarchical addressing correspondence of FIG. 8B was able to accommodate within that time span and only one quarter of the number of STAs which the hierarchical addressing correspondence of FIG. 8A was able to accommodate within that time span. On the other hand, the hierarchical addressing correspondence of FIG. 8C, by virtue of having sixteen 100 ms wide pages, may allow STAs to have TWTs within a time span of 0-1600 ms, outstripping both the 0-400 ms span provided for by the hierarchical addressing correspondence of FIG. 8A and the 0-800 ms span provided for by the hierarchical addressing correspondence of FIG. 8B.

Additionally according to the illustrative example, the AP may choose amongst the hierarchical addressing correspondence of FIG. 8A which corresponds to a first AID addressing hierarchy mode, the hierarchical addressing correspondence of FIG. 8B which corresponds to a second AID addressing hierarchy mode, and the hierarchical addressing correspondence of FIG. 8C which corresponds to a third AID addressing hierarchy mode depending on the circumstances at hand such as STA indications of desired TWTs and/or TWTs already assigned to STAs. As such, where a large portion of STAs have and/or desire TWTs within the span 0-400 ms, the AP may select the first AID addressing hierarchy mode. Where the TWTs held and/or desired by STAs are more evenly distributed within the span 0-1600 ms, the AP may select the third AID addressing hierarchy mode. For circumstances of held and/or desired STA TWTs falling between the two aforementioned, the AP may select the middle ground of the second AID addressing hierarchy mode.

Also further according to the illustrative example, the AP may be optionally able to perform one or more of TWT reassignment wherein new TWTs may be provided to STAs already possessing TWTs, and deciding the extent to which to meet STA requests for particular desired TWTs received from STA which do not already possess TWTs. As such, consideration of the addressing hierarchy mode to employ may be performed so as to choose the addressing mode which allows as many as possible STAs already possessing TWTs to keep those TWTs and/or which allows as many as possible STAs not already possessing TWTs to receive TWTs which they desire. For instance, where the majority of STAs already possessing TWTs possess TWTs within the span 0-400 ms and/or where the majority of STAs not already possessing TWTs desire TWTs within the span 0-400 ms, but nevertheless a few STAs already possess and/or desire TWTs outside of 0-400 ms, the AP may according to at least one example embodiment select the first AID addressing hierarchy mode, and reassign to STAs already possessing TWTs outside of 0-400 ms new TWTs falling within 0-400 ms, and/or provide to STAs desiring TWTs outside of 0-400 TWTs within 0-400 ms. In such reassignment of TWTs and/or provision of TWTs other than those desired, the AP may optionally attempt to provide STAs with TWTs as close as possible to those already held and/or those desired (e.g., a STA desiring a TWT outside of 0-400 ms may be given a TWT towards the 400 ms end of 0-400 ms).

Further according to the illustrative example, the AP may select a TWT for the STA for which association is taking place, and also may determine whether or not there will be an addressing change. Turning to the STA for which association is taking place, the AP may indicate (e.g., via an association response frame) the chosen TWT to the STA implicitly by providing to the STA the AID which corresponds to that TWT (e.g., with the AP perhaps consulting precalculations in order to learn of the AID which correlates with the particular TWT and/or with the AP perhaps preforming a calculatory reverse on the discussed operations which take in an AID and output a corresponding TWT). The AP may also indicate (e.g., via an association response frame) to the STA the addressing mode being employed (e.g., via an AID addressing hierarchy mode indicator conveyed via AID bits).

Still further according to the illustrative example, turning to already-associated STAs, where there is no change of addressing mode and where none of the already-associated STAs are to receive new TWTs, the AP may not communicate with the already-associated STAs responsive to the association of the new STA. Where there is a change of addressing mode and/or where one or more already-associated STAs are to receive new TWTs, the AP may commence an AID reassignment phase. It is noted that under the circumstance where there is an addressing mode change, but where one or more already-associated STAs are to keep their existing TWTs, during the AID reassignment phase such STAs may receive (e.g., via reassignment frame) AIDs which are possibly different, but which nevertheless map to the existing TWTs, with the new addressing mode perhaps being conveyed to those already-associated STAs (e.g., via an AID addressing hierarchy mode indicator conveyed via AID bits). For already-associated STAs receiving new TWTs, the AP may indicate during the AID reassignment phase those new TWTs implicitly to those STAs by providing (e.g., via reassignment frame) to each such STA the AID which corresponds to that STA's new TWT. At least in the case of an addressing mode change, the AP may further indicate to those STAs receiving new TWTs the current addressing mode (e.g., via an AID addressing hierarchy mode indicator conveyed via AID bits). In conveying TWTs implicitly to already-associated STAs, the AP may, for instance, consult precalculations in order to learn of the AID which correlates with a particular TWT, and/or may perform a calculatory reverse on the discussed operations which take in an AID and output a corresponding TWT. The employment of an AID reassignment phase may provide potential benefits including avoiding the disassociation of already-associated STAs, avoiding the performance of association with respect to already-associated STAs, and/or only performing association with respect to the STA for which association is taking place. In accordance with at least one example embodiment, the AP may perform a new association with respect to one or more already-associated STAs rather than avoiding such new association by performing AID reassignment.

Additionally according to the illustrative example, according to one scenario association may commence between an AP and a first STA (e.g., perhaps including the STA sending an association request to the AP), the STA may optionally specify one or more desired TWTs. The STA may receive from the AP (e.g., via an association response frame) an AID which implicitly indicates the TWT to be employed by that STA, the AID perhaps also conveying (e.g., via the two most significant bits of the AID) the AID addressing mode being employed. Then, at a later point in time—such as in response to an association between the AP and a second STA—the AP may switch to a new AID addressing hierarchy mode. Due to the new addressing mode, the first STA may receive from the AP, via an AID reassignment phase, a new AID which conveys the new addressing mode (e.g., via an AID addressing hierarchy mode indicator conveyed via AID bits). Depending on the circumstances at hand and the determinations of the sort discussed above performed by the AP, the new AID implicitly may convey to the first STA either the STA's current TWT or a different TWT. As such, according to at least one example embodiment an AP may perform on-the-fly change of AID addressing hierarchy mode, change of TWTs, and/or change of AIDs while a network made up of the AP and one or more associated STAs is operational.

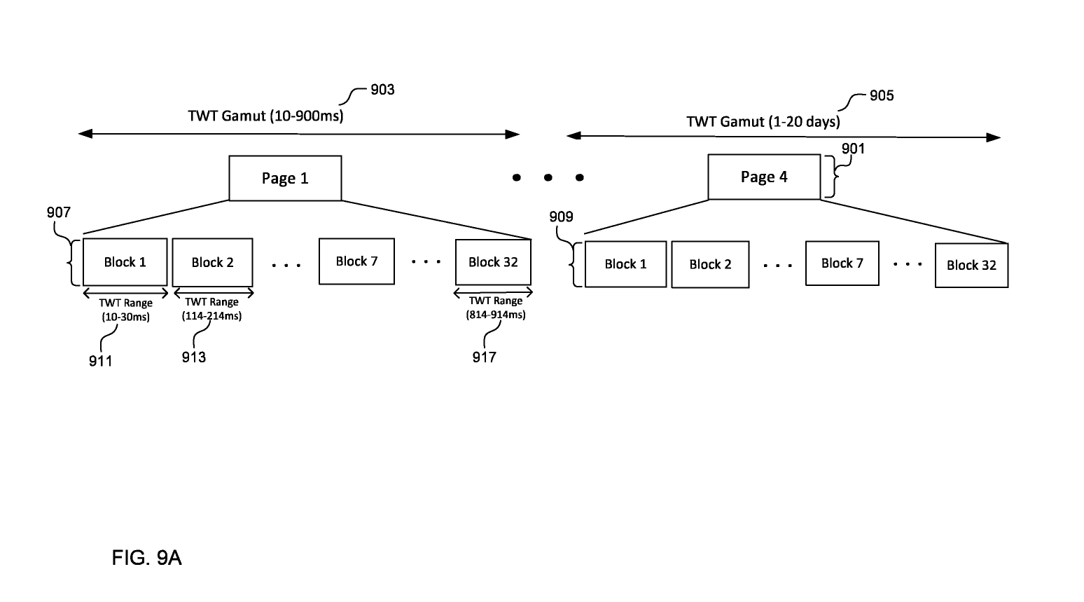

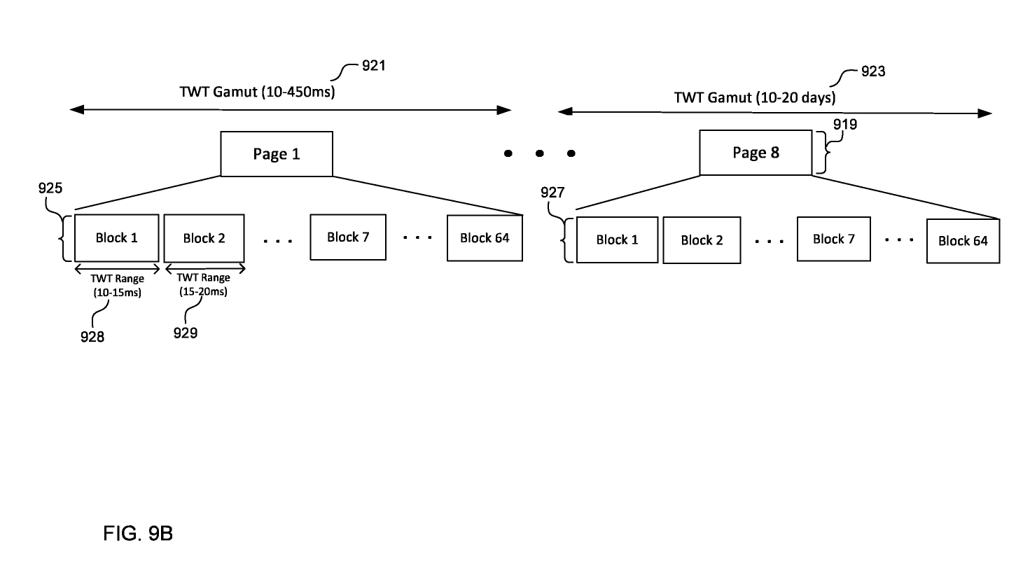

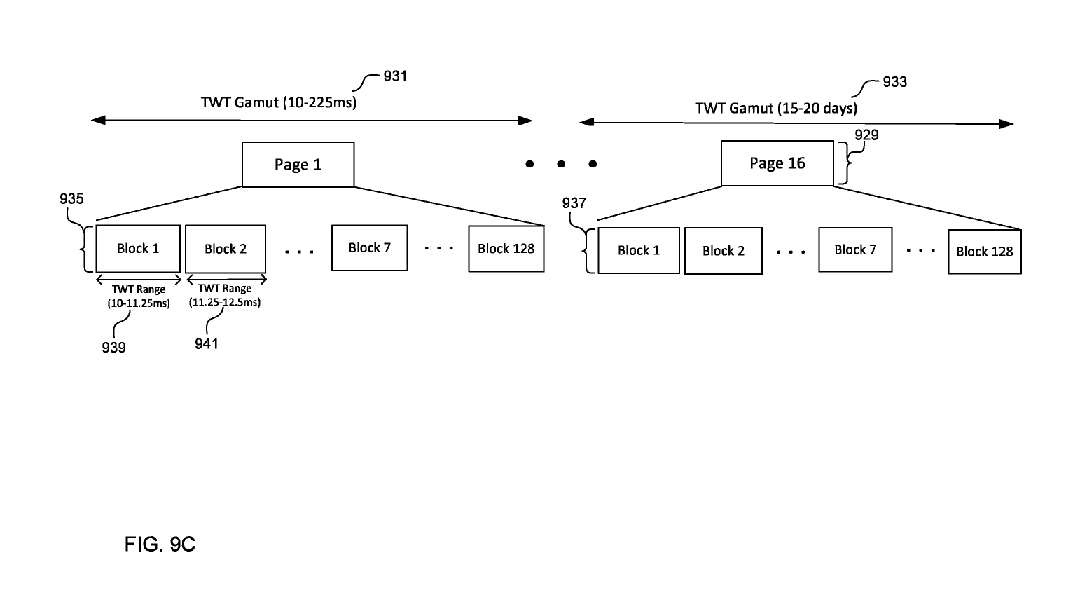

Also according to the illustrative example, shown in FIGS. 9A-9C are three further TWT hierarchical addressing correspondences in accordance with at least one example embodiment. The TWT hierarchical addressing correspondences of FIGS. 9A-9C apply respectively to the AID addressing hierarchy modes of FIGS. 2A-2C. The four pages (901) of FIG. 9A are page 1 through page 4. Pages 1 and 4 are explicitly shown, and pages 2 and 3 are conveyed via an ellipsis. Page 1 may have a TWT gamut (903) which spans from 10-900 ms, page 2 may have a TWT gamut which spans from 1-3500 s, page 3 may have a TWT gamut which spans from 1-24 hours, and page 4 may have a TWT gamut (905) which spans from 1-20 days. Pages 1-4 may each include 32 blocks. Depicted in FIG. 9A are the 32 blocks of page 1 (907), with blocks 1, 2, 7, and 32 being explicitly shown, and blocks 3-6 and 8-31 thereof being conveyed via ellipses. Also depicted in FIG. 9A are the 32 blocks of page 4 (909), with blocks 1, 2, 7, and 32 being explicitly shown, and blocks 3-6 and 8-31 thereof being conveyed via ellipses. Block 1 of page 1 may have a TWT range (911) which spans from 10-30 ms, block 2 of page 1 may have a TWT range (913) which spans from 114-214 ms, and block 32 of page 1 may have a TWT range (917) which spans from 814-914 ms. To facilitate description, the TWT ranges of the other blocks of FIG. 9A are not discussed. Each block of FIG. 9A may contain eight SBs, and each SB may contain eight AID address locations. As such, block 1 of page 1, by virtue of having eight SBs each of which contains eight AID address locations, may allow sixty-four STAs to have TWTs within the TWT time span 10-30 ms. Likewise, block 2 of page 1 may allow 64 STAs to have TWTs within the time span 114-214 ms, and block 32 of page 1 may allow sixty-four STAs to have TWTs within the time span 814-914 ms. To facilitate illustration, FIG. 9A does not depict SBs or AID address locations.

Further according to the illustrative example, the eight pages (919) of FIG. 9B are page 1 through page 8. Pages 1 and 8 are explicitly shown, and pages 2-7 are conveyed via an ellipsis. Page 1 may have a TWT gamut (921) which spans from 10-450 ms, page 2 may have a TWT gamut which spans from 451-900 ms, page 3 may have a TWT gamut which spans from 1-1700 s, page 4 may have a TWT gamut which spans from 1701-3500 s, page 5 may have a TWT gamut which spans from 1-12 hours, page 6 may have a TWT gamut which spans from 12.1-24 hours, page 7 may have a TWT gamut which spans from 1-10 days, and page 8 may have a TWT gamut which spans from 10.1-20 days.

Still further according to the illustrative example considering the AID addressing hierarchy mode of FIG. 9A with the AID addressing hierarchy mode of FIG. 9B, each TWT gamut of FIG. 9A may be viewable as being subdivided so as to yield two TWT gamuts of FIG. 9B. By such view, the FIG. 9A TWT gamut of 10-900 ms may be subdivided so as to yield the TWT gamuts 10-450 ms and 451-900 ms of FIG. 9B, the FIG. 9A TWT gamut of 1-3500 s may be subdivided so as to yield the TWT gamuts 1-1700 s and 1701-3500 s of FIG. 9B, the FIG. 9A TWT gamut of 1-24 hours may be subdivided so as to yield the TWT gamuts 1-12 hours and 12.1-24 hours of FIG. 9B, and the FIG. 9A TWT gamut of 1-20 days may be subdivided so as to yield the TWT gamuts 1-10 days and 10.1-20 days of FIG. 9B.

Also according to the illustrative example, pages 1-8 may each include 64 blocks. Depicted in FIG. 9B are the 64 blocks of page 1 (925), with blocks 1, 2, 7, and 64 being explicitly shown, and blocks 3-6 and 8-63 thereof being conveyed via ellipses. Also depicted in FIG. 9B are the 64 blocks of page 8 (927), with blocks 1, 2, 7, and 64 being explicitly shown, and blocks 3-6 and 8-63 thereof being conveyed via ellipses. Block 1 of page 1 may have a TWT range (928) which spans from 10-15 ms and block 2 of page 1 may have a TWT range (929) which spans from 15-20 ms. Each block of FIG. 9B may contain four SBs, and each SB may contain four AID address locations. As such, block 1 of page 1, by virtue of having four SBs each of which contains four AID address locations, may allow 16 STAs to have TWTs within the time span 10-15 ms. Likewise, block 2 of page 1 may allow 16 STAs to have TWTs within the time span 15-20 ms. To facilitate illustration, FIG. 9B does not depict SBs or AID address locations.

Additionally according to the illustrative example, considering the AID addressing hierarchy mode of FIG. 9A with the AID addressing hierarchy mode of FIG. 9B, each TWT range of FIG. 9A may be viewable as being subdivided so as to yield four TWT ranges of FIG. 9B. By such view, illustratively the FIG. 9A TWT range of 10-30 ms may be subdivided so as to yield the TWT ranges 10-15 ms, 15-20 ms, 20-25 ms, and 25-30 ms (the first two such ranges being depicted in FIG. 9B and the second two ranges, to facilitate illustration, not being depicted in FIG. 9B).

Further according to the illustrative example, the 16 pages (929) of FIG. 9C are page 1 through page 16. Pages 1 and 16 are explicitly shown, and pages 2-15 are conveyed via an ellipsis. Each TWT gamut of FIG. 9B may be viewable as being subdivided so as to yield two TWT gamuts of FIG. 9C. By such view, the FIG. 9B TWT gamut of 10-450 ms may be viewable as being subdivided so as to yield in FIG. 9C the page 1 TWT gamut (931) which spans from 10-225 ms and the page 2 TWT gamut which spans from 226-450 ms, the FIG. 9B TWT gamut of 10-20 days may be viewable as being subdivided so as to yield in FIG. 9C the page 15 TWT gamut which spans from 10-14 days and the page 16 TWT gamut (933) which spans from 15-20 days. The TWT gamuts of the other pages of FIG. 9C may follow the same pattern linking the TWT gamuts of FIG. 9B and the TWT gamuts of FIG. 9C.

Still further according to the illustrative example, pages 1-16 may each include 128 blocks. Depicted in FIG. 9C are the 128 blocks of page 1 (935), with blocks 1, 2, 7, and 128 being explicitly shown, and blocks 3-6 and 8-127 thereof being conveyed via ellipses. Also depicted in FIG. 9C are the 128 blocks of page 16 (937), with blocks 1, 2, 7, and 64 being explicitly shown, and blocks 3-6 and 8-127 thereof being conveyed via ellipses. Each block of FIG. 9C may contain two SBs, and each SB may contain 2 AID address locations. As such, each block may allow four STAs to have TWTs within the time span established by its corresponding TWT range.

Also according to the illustrative example, each TWT range of FIG. 9B may be viewable as being subdivided so as to yield four TWT ranges of FIG. 9C. By such view, the FIG. 9B TWT range of 10-15 ms may be viewable as being subdivided so as to yield in FIG. 9C the page 1, block 1 TWT range (939) which spans from 10-11.25 ms, the page 1, block 2 TWT range (941) which spans from 11.25-12.5 ms, the page 1, block 3 TWT range which spans from 12.5-13.75 ms, and the page 1, block 4 TWT range which spans from 13.75-15 ms. The other TWT ranges of FIG. 9C may follow the same patterning linking the TWT ranges of FIG. 9B and the TWT ranges of FIG. 9C.

Additionally according to the illustrative example, the AID addressing hierarchy mode of FIG. 9A may be viewable as being appropriate where a large number of STAs have TWTs which are clumped closely together in value, with there perhaps being a lack of large swathes of time between TWTs. As a non-limiting example, such circumstances may arise where there is a large number of TWTs within one or a few TWT ranges, with TWTs perhaps not being spread out over many TWT gamuts. As a particular example, the addressing mode of FIG. 9A may be viewable as being appropriate where during the associations of 210 STAs 48 STAs request TWTs within 10-30 ms, 40 STAs request TWTs within 1-100 s, 64 STAs request TWTs within 1-1.5 hours, and 58 STAs request TWTs within 1-2 days.

Further according to the illustrative example, the AID addressing hierarchy mode of FIG. 9C may be viewable as being appropriate where there are instances of large swathes of time between TWTs, with there perhaps being a lack of large numbers of STAs having TWTs which are clumped closely together in value. As a non-limiting example, such circumstances may arise where each TWT range possesses a small number of TWTs, but where TWTs may be spread out over many TWT gamuts.

Still further according to the illustrative example, the AID addressing hierarchy mode of FIG. 9B may be viewable as being appropriate for circumstances which fall between those discussed as being appropriate for the addressing mode of FIG. 9A and those discussed as being appropriate for the addressing mode of FIG. 9C. As a non-limiting example, such circumstances may arise where there is a moderate number of TWTs within one or a few TWT ranges, with TWTs perhaps being spread out over a moderate number of TWT gamuts. As a particular example, the addressing mode of FIG. 9B may be viewable as being appropriate where during the associations of 210 STAs, 100 STAs request TWTs within 10-30 ms, 80 STAs request TWTs within 1-100 s, and the remainder of the 210 STAs request TWTs having values measured in hours and/or days.

Still further according to the illustrative example, mode employment and/or change discussed herein may optionally occur and/or be indicated to STAs without implicit TWT assignment, without AID reassignment occurring with respect to those STAs, and/or with those STAs maintaining their AIDs. Such AID maintenance may, where mode change involves a change in AID length (e.g., from thirteen bits to fifteen bits) involve bit padding (e.g., with a STA employing padding to maintain its AID value in the face of change in specified AID length). Moreover, STAs discussed herein may optionally be TIM and/or non-TIM STAs (e.g., where mode change occurs and/or is indicated to STAs without implicit TWT assignment). Further, STAs discussed herein may optionally not be the subject of implicit TWT assignment.

### Multiple Mode Identifier Addressing—Hierarchical Identifier Structure Encoding Functionality

Multiple mode identifier (e.g., AID) addressing, hierarchical identifier (e.g., AID) structure encoding functionality according to at least one example embodiment will now be discussed. As discussed in greater detail herein, one or more hierarchical AID structures may be formulated (e.g., by an AP). Such hierarchical AID structures may, as non-limiting examples, be maintained by an AP and/or be dispatched, in whole or in part, to one or more STAs.

As an illustrative example of such functionality, formulated (e.g., by an AP) may be a hierarchical AID structure which may support a first addressing mode (e.g., considered “mode 1”), a second addressing mode (e.g., considered “mode 2”), and/or a third addressing mode (e.g., considered “mode 3”). The first addressing mode may allow for four pages, 32 blocks within each page, eight SBs within each block, and eight AID address locations in each SB, with each such AID address location corresponding to the AID of a STA, yielding a per-page STA capacity of 2048 STAs. The second addressing mode may allow for four pages, 64 blocks within each page, seven SBs within each block, and eight AID address locations in each SB with each such AID address location corresponding to the AID of a STA, yielding a per-page STA capacity of 3584 STAs. The third addressing mode may allow for four pages, 128 blocks within each page, six SB within each block, and eight AID address locations in each SB with each such AID address location corresponding to the AID of a STA, yielding a per-page STA capacity of 6144 STA.

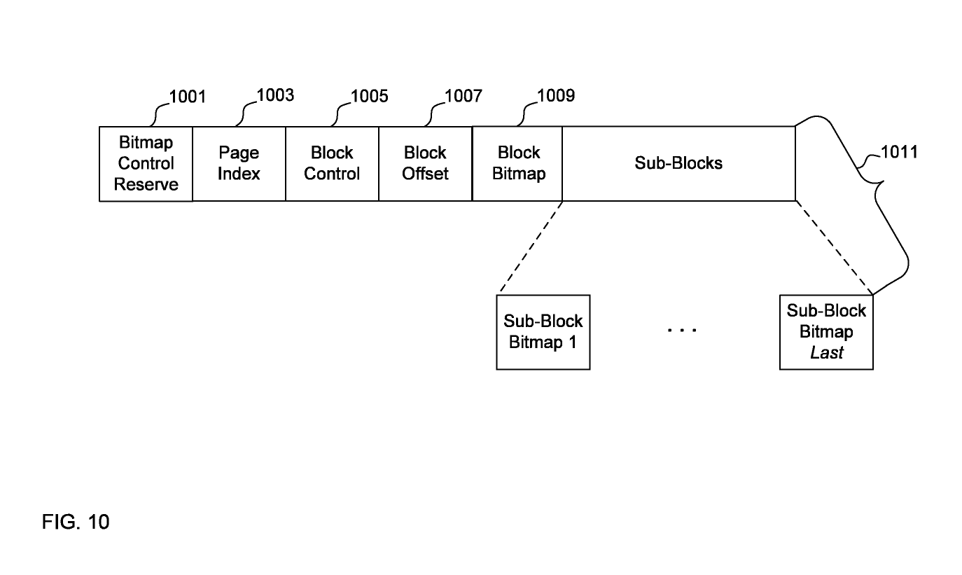

Further according to the illustrative example, the noted hierarchical AID structure may be implemented as depicted in FIG. 10, FIG. 10 showing a hierarchical AID structure according to at least one example embodiment. The hierarchical AID structure may include six bitmap control reserve bits 1001, two bits of page index 1003 allowing for the four pages noted for each of the three modes, three bits of block control 1005 allowing for, in each of the modes, indication of application of block bit map and SB bitmap (e.g., in accordance with block bitmap encoding), a quantity of bits of block offset 1007—the bit quantity depending on the particular mode to which the hierarchical AID structure is applied—allowing for the noted number of blocks per page for that particular mode (e.g., allowing for 64 blocks per page when the particular mode is the second mode), a quantity of bits of block bitmap 1009—the bit quantity depending on the particular mode to which the hierarchical AID structure is applied—allowing for the noted number of SB per block for that particular mode (e.g., allowing for seven SB per block when the particular mode is the second mode), and the eight bits of SB bitmap per SB referenced by 1011 allowing for the eight AID address locations in each SB noted for each of the three modes.

Still further according to the illustrative example, for the first mode block control 1005 may remain three bits, block offset 1007 may be set as five bits, and block bitmap 1009 may be set as eight bits. For the second mode block control 1005 may remain three bits, block offset 1007 may be set as six bits, and block bitmap 1009 may be set as seven bits. For the third mode block control 1005 may remain three bits, block offset 1007 may be set as seven bits, and block bitmap 1009 may be set as six bits. As such, for each of the three modes the quantity of bits amongst block control 1005, block offset 1007, and block bitmap 1009 sums to sixteen bits, thus allowing the same hierarchical AID structure to be employed for all three modes.

Additionally according to the illustrative example, while the same hierarchical AID structure may be employed for all three modes, the length of the counterpart AID (e.g., corresponding to the AID of a STA subject to that hierarchical AID structure) may vary in dependence of the particular mode employed. For each of the three modes, two bits (e.g., two page index bits) of the AID counterpart to the hierarchical AID structure may correspond to the two bits of page index 1003, and three of the total number of bits (e.g., three STA bit position index bits) of the AID counterpart to the hierarchical AID structure may correspond to the eight bits of SB bitmap per SB referenced by 1011. However, for the first mode five of the bits (e.g., five block index bits) of the AID counterpart to the hierarchical AID structure may correspond to five bits of block offset 1007 when the first mode is employed and three of the bits of the AID counterpart to the hierarchical AID structure (e.g., three SB index bits) may correspond to the eight bits of block bitmap 1009 when the first mode is employed. As such, the AID length for the first mode is thirteen bits. For the second mode, six of the bits (e.g., six block index bits) of the AID counterpart to the hierarchical AID structure may correspond to the six bits of block offset 1007 when the second mode is employed and three of the bits of the AID counterpart to the hierarchical AID structure (e.g., three SB index bits) may correspond to the seven bits of block bitmap 1009 when the second mode is employed, three bits of the AID being called for as two bits would only provide for four bits of block bitmap 1009 and thus fewer than the noted seven bits of block bitmap at hand when the second mode is employed. As such, the AID length for the second mode is fourteen bits. For the third mode, seven of the bits (e.g., seven block index bits) of the AID counterpart to the hierarchical AID structure may correspond to seven bits of block offset 1007 when the third mode is employed and three of the bits of the AID counterpart to the hierarchical AID structure (e.g., three SB index bits) may correspond to the six bits of block bitmap 1009 when the third mode is employed, three bits of the AID being called for as two bits would only provide for four bits of block bitmap 1009 and thus fewer than the noted six bits of block bitmap at hand when the third mode is employed. As such, the AID length for the third mode is fifteen bits.

Further according to the illustrative example, there may be indication of such addressing modes. As non-limiting examples such indication may be dispatched (e.g., by the AP to the one or more STAs) via bits (e.g., via two bits), via beacon frame, via association response, via AID (e.g., where the indication is the AID of the device to which indication is dispatched), via one or more fields (e.g., via an AID mode field), before AID indication, after AID indication, with AID indication (e.g., where the AP dispatches to a STA the AID of that STA, and that AID serves as the addressing mode indication), and/or via hierarchical AID structure. As a particular non-limiting example, the AP might dispatch such addressing mode indication to one or more STAs via an AID mode field in a beacon frame. As a further non-limiting example, the bits “00” may convey the first mode, the bits “01” may convey the second mode, the bits “10” may convey the third mode, and the bits “11” may be considered reserved. The first mode may optionally be set as a default mode. A STA so receiving such addressing mode indication may learn therefrom the addressing mode to be employed and/or adjust its operation accordingly (e.g., learn and/or act in accordance with the number of pages, number of blocks per page, number of SBs per block, and/or number of AID address locations per SB). As a non-limiting example, the STA may access a data store in view of the addressing mode indication to learn the number of pages, number of blocks per page, number of SBs per block, and/or number of AID address locations per SB to be employed for the indicated mode.

Still further according to the illustrative example, as noted the first addressing mode may have a per-page STA capacity of 2048 STAs, the second addressing mode may have a per-page STA capacity of 3584 STAs, and the third addressing mode may have a per-page STA capacity of 6144 STAs. STAs may optionally be grouped in view of hierarchical structure. As non-limiting examples, STAs may be grouped according to page, block, SB, segmented page, segmented block and/or segmented SB. TIM segmentation and/or page segmentation may optionally be employed. As a non-limiting example, gas and/or other meter and/or sensor STAs may be grouped by page with each page corresponding to a neighborhood (e.g., a neighborhood with in excess of 2500 sensors). As a non-limiting example, considering an assignment scenario wherein in excess of 2500 STAs may be assigned per page (e.g., with each page corresponding to a neighborhood and there being in excess of 2500 sensor STAs per neighborhood page), the second addressing mode, allowing for 3584 STA per page, and the third addressing mode, allowing for 6144 STAs per page, may be employable options. More generally, as a non-limiting example where STAs may be grouped as noted in view of hierarchical structure (e.g., by page and/or segmented page), circumstance may arise where of import is the quantity of STAs that can be accommodated by a particular hierarchal element (e.g., a particular page). Circumstance may arise where an insufficient quantity of STAs accommodatable per particular hierarchical element (e.g., particular page) may mean that a particular element (e.g., particular page) to which a STA need to be assigned (e.g., the element corresponding to a STA class of which the STA is a member) may be full even though room remains in other like elements (e.g., other pages) of the hierarchy, but the STA cannot be appropriately assigned to those other like elements (e.g., those other like elements correspond to STA classes of which the STA is not a member). As another non-limiting example, STAs may be grouped by page in view of priority and/or use mode such that audio and/or video access STAs are assigned to a particular page, textual and/or still image STA are assigned to a particular page, and/or sensor STAs are assigned to a particular page.

Also according to the illustrative example, considering pages being segmented into sixteen segments per page, for the first addressing mode each page has a STA capacity of 2048, and segmenting each page into sixteen segments (e.g., sixteen TIM segments) may yield 128 STAs per segment. For the second addressing mode each page has a STA capacity of 3584 and segmenting each page into sixteen segments (e.g., sixteen TIM segments) may yield 224 STA per segment. For the third addressing mode each page has a STA capacity of 6144 and segmenting each page into sixteen segments (e.g., sixteen TIM segments) may yield 384 STA per segment. As a non-liming example, considering a page segment (e.g., TIM segment) of a given time length (e.g., 100 ms), the noted 128 STAs per segment having medium access for that given time length (e.g., 100 ms) may be viewed as inefficient use of the medium. In contrast, the noted 224 STAs per segment having medium access for that given time length (e.g., 100 ms), and/or the noted 384 STAs per segment having medium access for that given time length (e.g., 100 ms) may be viewed as efficient use of the medium.

Additionally according to the illustrative example, formulated (e.g., by an AP) may be a hierarchical AID structure which may support an addressing mode (e.g., considered “mode 1”) allowing for four pages, 32 blocks within each page, eight SBs within each block, and eight AID address locations in each SB, with each such AID address location corresponding to the AID of a STA. Alternately or additionally, formulated (e.g., by an AP) may be a hierarchical AID structure which may support an addressing mode (e.g., considered “mode 2”) allowing for eight pages, 64 blocks within each page, four SBs within each block, and four AID address locations in each SB, with each such AID address location corresponding to the AID of a STA. Alternately or additionally, formulated (e.g., by an AP) may be a hierarchical AID structure which may support an addressing mode (e.g., considered “mode 3”) allowing for sixteen pages, 128 blocks within each page, two SBs within each block, and two AID address locations in each SB, with each such AID address location corresponding to the AID of a STA. Alternately or additionally, formulated (e.g., by an AP) may be a hierarchical AID structure which may support one or more addressing modes (e.g., a mode considered “mode 4”), such as an addressing mode instituted to realize a mode considered reserved.

Further according to the illustrative example, there may be indication of such addressing modes. As non-limiting examples such indication may be dispatched (e.g., by the AP to the one or more STAs) via bits (e.g., via two bits), via beacon frame, via association response, via AID (e.g., where the indication is the AID of the device to which indication is dispatched), via one or more fields (e.g., via an AID mode field), before AID indication, after AID indication, with AID indication (e.g., where the AP dispatches to a STA the AID of that STA, and that AID serves as the addressing mode indication), and/or via hierarchical AID structure. As a particular non-limiting example, the AP might dispatch such addressing mode indication to one or more STAs via an AID mode field in a beacon frame. As a further non-limiting example, the bits “00” may convey the discussed mode which allows in one aspect for four pages, the bits “01” may convey the discussed mode which allows in one aspect for eight pages, the bits “10” may convey the discussed mode which allows in one aspect for sixteen pages, and the bits “11” may be considered reserved. The discussed mode which allows in one aspect for four pages may optionally be set as a default mode. A STA so receiving such addressing mode indication may learn therefrom the addressing mode to be employed and/or adjust its operation accordingly (e.g., learn and/or act in accordance with the number of pages, number of blocks per page, number of SBs per block, and/or number of AID address locations per SB). As a non-limiting example, the STA may access a data store in view of the addressing mode indication to learn the number of pages, number of blocks per page, number of SBs per block, and/or number of AID address locations per SB to be employed for the indicated mode.

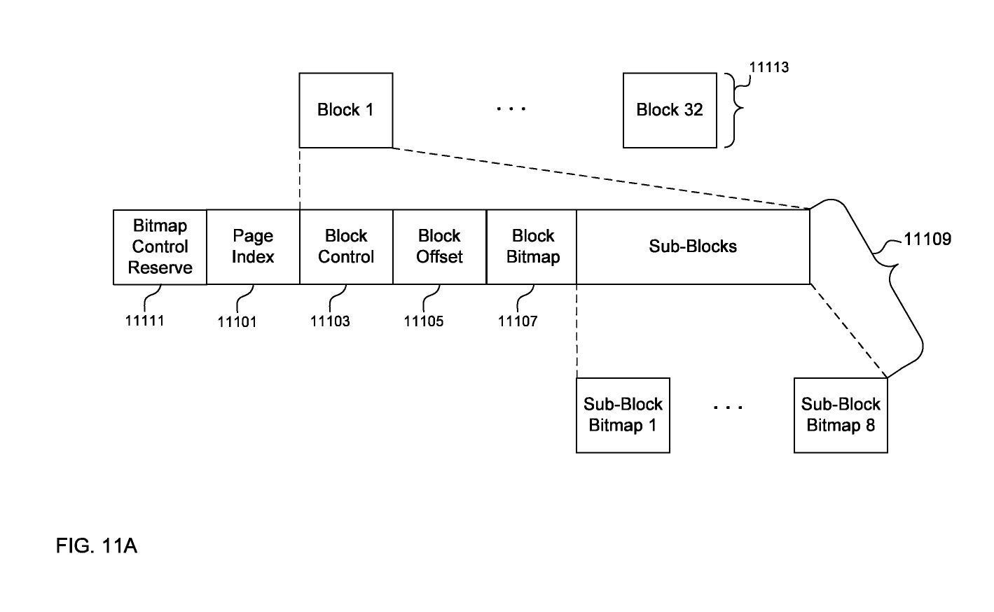

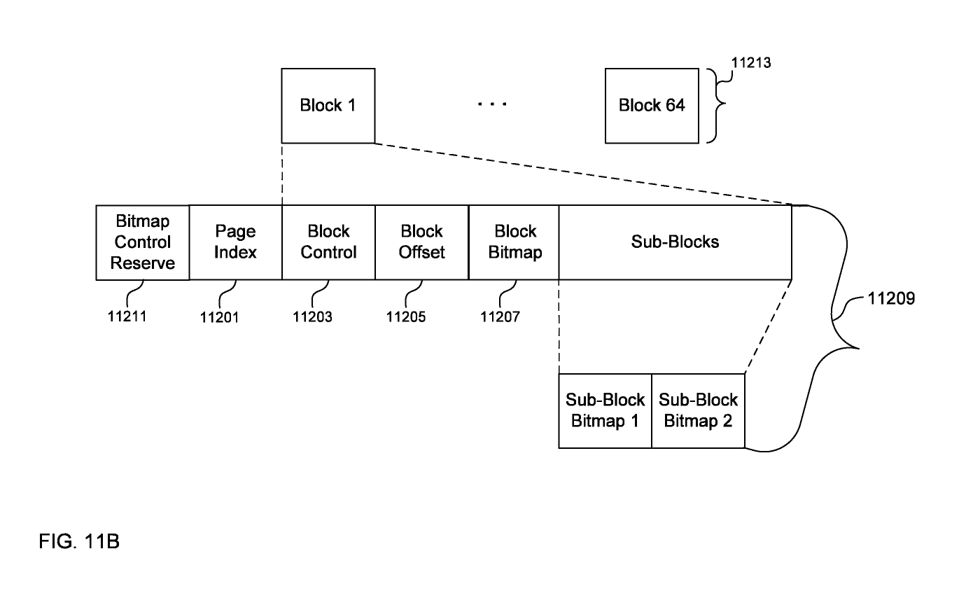

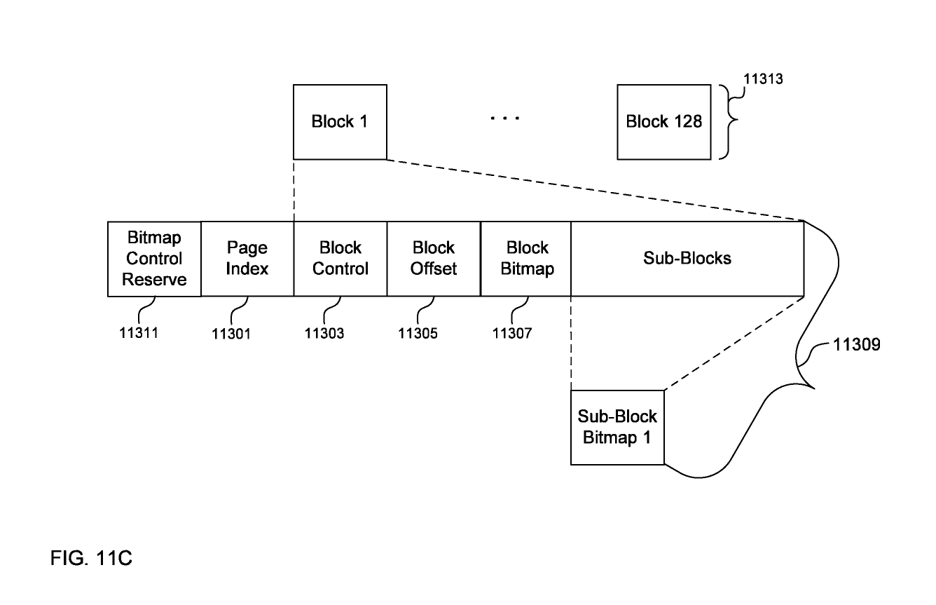

Still further according to the illustrative example, with reference to FIG. 11A, which shows a hierarchical AID structure according to at least one example embodiment, the discussed mode which allows in one aspect for four pages may include two bits of page index 11101 allowing for the noted four pages, three bits of block control 11103 allowing for indication of application of block bitmap and SB bitmap (e.g., in accordance with block bitmap encoding), five bits of block offset 11105 allowing for the noted 32 blocks, eight bits of block bitmap 11107 allowing for the noted eight SB, and eight bits of SB bitmap per SB 11109 allowing for the noted eight AID address locations. Optionally taken from bitmap control reserve bits 11111 may be two bits allowing for the noted addressing mode indication. Also depicted in FIG. 11A are blocks 1-32 (11113).

Also according to the illustrative example, with reference to FIG. 11B which shows a further hierarchical AID structure according to at least one example embodiment, the discussed mode which allows in one aspect for eight pages may include three bits of page index 11201 allowing for the noted eight pages, with one of those three bits being taken from bitmap control reserve bits 11211, three bits of block control 11203 allowing for indication of application of block bitmap and SB bitmap (e.g., in accordance with block bitmap encoding), six bits of block offset 11205 allowing for the noted 64 blocks, four bits of block bitmap 11207 allowing for the noted four SB, and four bits of SB bitmap per SB allowing for the noted four AID address locations. As to the noted four bits of SB bitmap per SB, two SB bitmap octets 11209 may be shared amongst the four SBs. The first four bits of the first SB bitmap octet may correspond to the four AID address locations of the first SB. The second four bits of the first SB bitmap octet may correspond to the four AID address locations of the second SB. The first four bits of the second SB bitmap octet may correspond to the four AID address locations of the third SB. The second four bits of the second SB bitmap octet may correspond to the four AID address locations of the fourth SB. Optionally, taken from bitmap control reserve bits 11211 may be two bits allowing for the noted addressing mode indication. Also depicted in FIG. 11B are blocks 1-64 (11213).

Additionally according to the illustrative example, with reference to FIG. 11C which shows an additional hierarchical AID structure according to at least one example embodiment, the discussed mode which allows in one aspect for sixteen pages may include four bits of page index 11301 allowing for the noted sixteen pages with two of those four bits being taken from bitmap control reserve bits 11311, three bits of block control 11303 allowing for indication of application of block bitmap and SB bitmap (e.g., in accordance with block bitmap encoding), seven bits of block offset 11305 allowing for the noted 128 blocks, two bits of block bitmap 11307 allowing for the noted two SB, and two bits of SB bitmap per SB allowing for the noted two AID address locations. As to the noted two bits of SB bitmap per SB, considering a SB bitmap octet 11309, half of the SB bitmap octet may be employed, the other half of the SB bitmap octet being employed in like fashion by the SBs of an adjacent block. Considering a first block and a second block, the first two bits of the SB bitmap octet may correspond to the two AID address locations of the first SB of the first block. The second two bits of the SB bitmap octet may correspond to the two AID address locations of the second SB of the first block. The third two bits of the SB bitmap octet may correspond to the two AID address locations of the first SB of the second block. The fourth two bits of the SB bitmap octet may correspond to the two AID address locations of the second SB of the second block. Optionally, taken from bitmap control reserve bits 11311 may be two bits allowing for the noted AID addressing indication. Also depicted in FIG. 11C are blocks 1-128 (1213).

Further according to the illustrative example, the hierarchical AID structure of FIG. 11A, the hierarchical AID structure of FIG. 11B, and the hierarchical AID structure of FIG. 11C may each have as an AID counterpart (e.g., corresponding to the AID of a STA subject to that hierarchical AID structure) a thirteen bit AID. Considering the hierarchical AID structure of FIG. 11A, two of the thirteen bits (e.g., two page index bits) of the AID counterpart to that hierarchical AID structure may correspond to the two bits of page index 11101, five of the thirteen bits (e.g., five block index bits) of the AID counterpart to that hierarchical AID structure may correspond to the five bits of block offset 11105, three of the thirteen bits (e.g., three SB index bits) of the AID corresponding to that hierarchical AID structure may correspond to the eight bits of block bitmap 11107, and three of the thirteen bits (e.g., three STA bit position index bits) of the AID counterpart to that hierarchical AID structure may correspond to the eight bits of SB bitmap per SB 11019. Considering the hierarchical AID structure of FIG. 11B, three of the thirteen bits (e.g., three page index bits) of the AID counterpart to that hierarchical AID structure may correspond to the three bits of page index 11201, six of the thirteen bits (e.g., six block index bits) of the AID counterpart to that hierarchical AID structure may correspond to the six bits of block offset 11205, two of the thirteen bits (e.g., two SB index bits) of the AID counterpart to that hierarchical AID structure may correspond to the four bits of block bitmap 11207, and two of the thirteen bits (e.g., two STA bit position index bits) of the AID counterpart to that hierarchical AID structure may correspond to the four bits of SB bitmap per SB noted in connection with that hierarchical AID structure. Considering the hierarchical AID structure of FIG. 11C, four of the thirteen bits (e.g., four page index bits) of the AID counterpart to that hierarchical AID structure may correspond to the four bits of page index 11301, seven of the thirteen bits (e.g., seven block index bits) of the AID counterpart to that hierarchical AID structure may correspond to the seven bits of block offset 11305, one of the thirteen bits (e.g., one SB index bit) of the AID counterpart to that hierarchical AID structure may correspond to the two bits of block bitmap 11307, and one of the thirteen bits (e.g., one STA bit position index bit) of the AID counterpart to that hierarchical AID structure may correspond to the two bits of SB bitmap per SB noted in connection with that hierarchical AID structure.

Still further according to the illustrative example, as referenced circumstance may arise where of import is the quantity of STAs that can be accommodated by a particular hierarchical element (e.g., a particular page, block, or SB). As such, satisfaction of such accommodation goals may be facilitated by the hierarchal structural diversity garnered by there being the addressing mode which allows for four pages, 32 blocks within each page, eight SBs within each block, and eight AID address locations in each SB, the addressing mode which allows for eight pages, 64 blocks within each page, four SBs within each block, and four AID address locations in each SB, and the addressing mode which allows for sixteen pages, 128 blocks within each page, two SBs within each block, and two AID address locations in each SB.

Additionally according to the illustrative example, with respect to both the noted functionality where, with addressing mode change, AID length may change, and the noted functionality where, with addressing mode change, AID length may remain unchanged, the AP may optionally perform a best addressing mode determination considering the quantity of STAs that can, employing the current addressing mode, be accommodated by one or more particular hierarchical elements (e.g., one or more particular pages, blocks and/or SBs) in view of one or more accommodation goals (e.g., the quantity of STAs to be assigned such particular elements). Where the AP determines that a change of addressing mode may better allow the satisfaction of such goals, the AP may select a new addressing mode and/or inform one or more STAs of the change. Alternately or additionally, where no addressing mode is being employed, the AP may determine an addressing mode to be employed by considering for each of multiple addressing modes the quantity of STAs that can, employing that addressing mode, be accommodated by one or more particular hierarchical elements (e.g., one or more particular pages, blocks and/or SBs) in view of one or more accommodation goals (e.g., the quantity of STAs to be assigned such particular elements). Where the AP determines that a particular one of the addressing modes allows for proper satisfaction of such goals (e.g., better satisfaction of such goals than other ones of the considered modes), the AP may select that addressing mode and/or inform one or more STAs of the mode. As such, according to at least one example embodiment the AP performs on-the-fly change of addressing mode in view of such goals.

Further according to the illustrative example, with respect to both the noted functionality where, with addressing mode change, AID length may change, and the noted functionality where, with addressing mode change, AID length may remain unchanged, the noted indication of addressing mode via AID may involve a STA receiving an AID and, without receiving explicit indication of addressing mode, determining addressing mode from the AID. The STA may consider the length of page index bits of the AID and consider the mode to have a number of pages equal to two to the power of that length value. The STA may consider the length of block index bits of that AID and consider the mode to have a number of blocks per page equal to two to the power of that length value. The STA may consider the length of SB index bits of that AID and consider the mode to have a number of SBs per block equal to two to the power of that length value. The STA may consider the length of STA bit position index bits of that AID and consider the mode to have a number of AID address locations per SB equal to two to the power of that length value.

Still further according to the illustrative example, mode employment and/or change discussed herein may optionally occur and/or be indicated to STAs without implicit TWT assignment, without AID reassignment occurring with respect to those STAs, and/or with those STAs maintaining their AIDs. Such AID maintenance may, where mode change involves a change in AID length (e.g., from thirteen bits to fifteen bits) involve bit padding (e.g., with a STA employing padding to maintain its AID value in the face of change in specified AID length). Moreover, STAs discussed herein may optionally be TIM and/or non-TIM STAs (e.g., where mode change occurs and/or is indicated to STAs without implicit TWT assignment). Further, STAs discussed herein may optionally not be the subject of implicit TWT assignment.

### Hardware and Software

The foregoing discusses computers, such as the discussed AP and STA devices, performing a number of operations. Examples of computers may include smart cards, media devices, personal computers, engineering workstations, PCs PDAs, portable computers, computerized watches, wired and wireless terminals, telephones, communication devices, nodes, servers, network access points, network multicast points, network devices, network stations, set-top boxes, personal video recorders (PVRs), game consoles, portable game devices, portable audio devices, portable media devices, portable video devices, televisions, digital cameras, digital camcorders, Global Positioning System (GPS) receivers, sensors, and wireless personal servers.

Running on such computers are often one or more operating systems. Examples of operating systems include Windows Phone (e.g., Windows Phone 8 or Windows Phone 7), Windows (e.g., Windows 8, Windows 7, or Windows Vista), Windows Server (e.g., Windows Server 2012, Windows server 2008, or Windows Server 2003), Maemo, Symbian OS, WebOS, Linux, OS X, and iOS. Supported by such computers may optionally be one or more of the S60 Platform, the .NET Framework, Java, and Cocoa.

Examples of computers may also include one or more processors operatively connected to one or more memory or storage units, wherein the memory or storage optionally contains data, algorithms, and/or program code, and the processor or processors execute the program code and/or manipulate the program code, data, and/or algorithms.

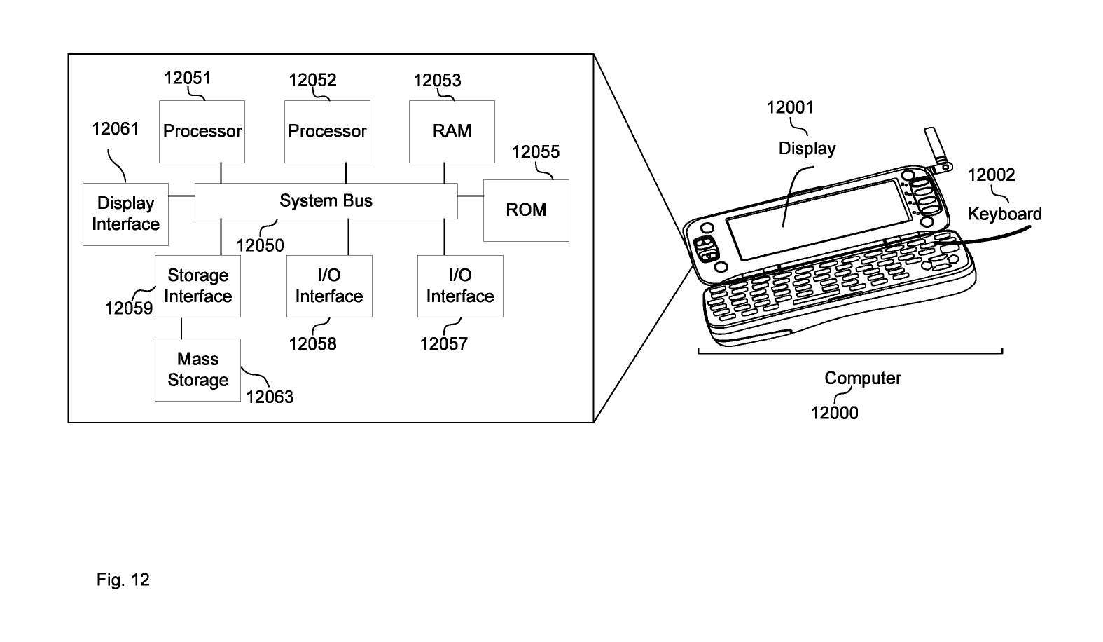

FIG. 12 shows example computer 12000 including system bus 12050 which may operatively connect two processors 12051 and 12052, random access memory 12053, read-only memory 12055, input output (I/O) interfaces 12057 and 12058, storage interface 12059, and display interface 12061. Storage interface 12059 may in turn connect to mass storage 12063. Each of I/O interfaces 12057 and 12058 may an Ethernet, IEEE 1394, IEEE 1394b, IEEE 802.11a, 802.11af, 802.11ah, IEEE 802.11b, IEEE 802.11g, IEEE 802.11i, IEEE 802.11e, IEEE 802.11n, IEEE 802.15a, IEEE 802.16a, IEEE 802.16d, IEEE 802.16e, IEEE 802.16m, IEEE 802.16x, IEEE 802.20, IEEE 802.22, IEEE 802.15.3, ZigBee (e.g., IEEE 802.15.4), Bluetooth (e.g., IEEE 802.15.1), Ultra Wide Band (UWB), Wireless Universal Serial Bus (WUSB), wireless Firewire, terrestrial digital video broadcast (DVB-T), satellite digital video broadcast (DVB-S), Advanced Television Systems Committee (ATSC), Integrated Services Digital Broadcasting (ISDB), Digital Multimedia Broadcast-Terrestrial (DMB-T), MediaFLO (Forward Link Only), Terrestrial Digital Multimedia Broadcasting (T-DMB), Digital Audio Broadcast (DAB), Digital Radio Mondiale (DRM), General Packet Radio Service (GPRS), Universal Mobile Telecommunications Service (UMTS), Long Term Evolution (LTE), Global System for Mobile Communications (GSM), Code Division Multiple Access 2000 (CDMA2000), DVB-H (Digital Video Broadcasting: Handhelds), HDMI (High-Definition Multimedia Interface), Thunderbolt, or IrDA (Infrared Data Association) interface.

Further according to FIG. 12 mass storage 12063 may be a hard drive or flash memory. Each of processors 12051 and 12052 may be an ARM-based processor or an x86-based processor. Computer 12000 as shown in this example may also include a touch screen 12001 and physical keyboard 12002. Optionally a mouse or keypad may alternately or additionally be employed. Moreover, one or more of touch screen 12001 and physical keyboard 12002 may optionally be eliminated.

Additionally according to FIG. 12 computer 12000 may optionally include or be attached to one or more image capture devices. Examples of image capture devices may include ones employing Complementary Metal Oxide Semiconductor (CMOS) hardware and ones employing Charge Coupled Device (CCD) hardware. One or more of the image capture devices may according to one example of an implementation be aimed towards the user. Alternately or additionally, one or more of the image capture devices may be aimed away from the user. The one or more image capture devices may optionally be employed by computer 12000 for video conferencing, still image capture, and/or video capture. Moreover, computer 12000 may optionally include or be attached to one or more card readers, DVD drives, floppy disk drives, hard drives, memory cards, or ROM devices whereby media containing program code—such as program code for performing the discussed operations—is optionally inserted for the purpose of loading the code onto the computer. Further, program code—such as program code for performing the discussed operations—may be optionally loaded the code onto the computer via one or more of I/O interfaces 12057 and 12058, perhaps using one or more networks.

According to an example of an implementation, executed by computers discussed herein may be one or more software modules designed to perform one or more of the discussed operations. Such modules are programmed using one or more languages. Examples of languages include C#, C, C++, Objective C, Java, Perl, and Python. Corresponding program code may be optionally placed on media. Examples of media include DVD, CD-ROM, memory card, and floppy disk.

Any indicated division of operations among particular software modules is for purposes of illustration, and alternate divisions of operation are possible. Accordingly, any operations indicated to be performed by one software module may according to an alternative implementation instead be performed by a plurality of software modules. Similarly, any operations indicated to be performed by a plurality of modules may according to an alternative implementation instead be performed by a single module.

Further, any operations indicated to be performed by a particular computer such as a particular device may according to an alternative implementation instead be performed by a plurality of computers such as by a plurality of devices. Moreover, peer-to-peer, cloud, and/or grid computing techniques may optionally be employed. Additionally, implementations may include remote communication among software modules. Examples of remote communication techniques include Simple Object Access Protocol (SOAP), Java Messaging Service (JMS), Remote Method Invocation (RMI), Remote Procedure Call (RPC), sockets, and pipes.

Optionally, operations discussed herein may be implemented via hardware. Examples of such implementation via hardware include the use of one or more of integrated circuits, specialized hardware, chips, chipsets, Application-Specific Integrated Circuits (ASICs), and Field-Programmable Gate Arrays (FPGAs). As a non-limiting example such hardware may be programmed to perform operations discussed herein using one or more languages such as one or more Hardware Description Languages (HDLs). Examples of HDLs include very-high-speed integrated circuit hardware description language (VHDL) and Verilog.

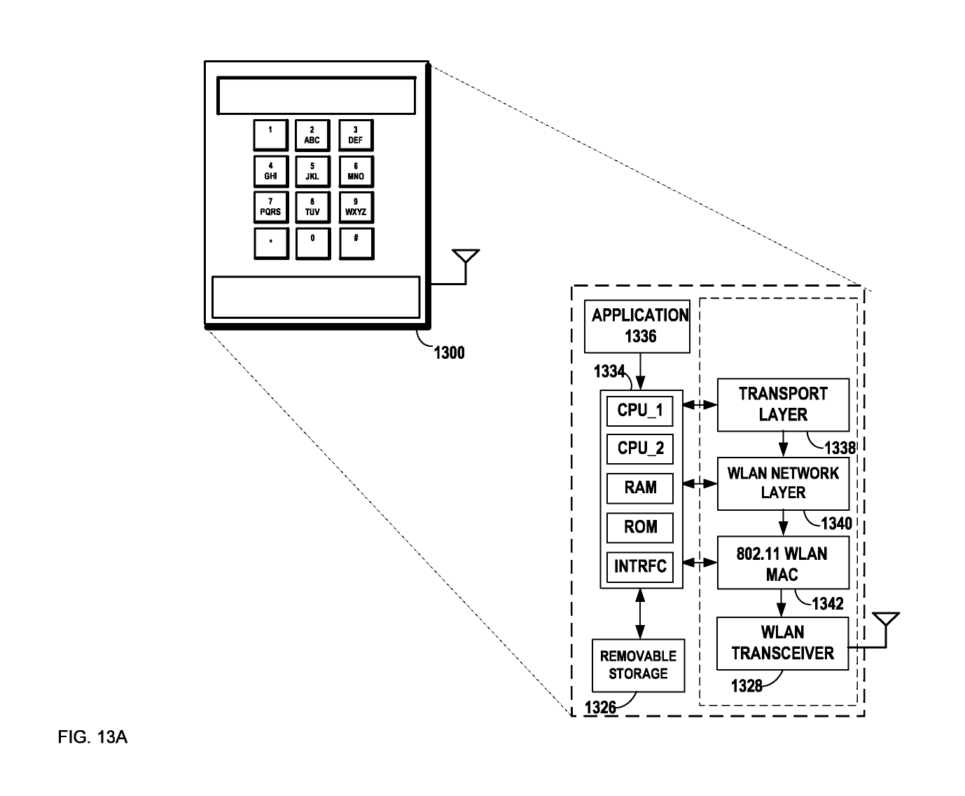

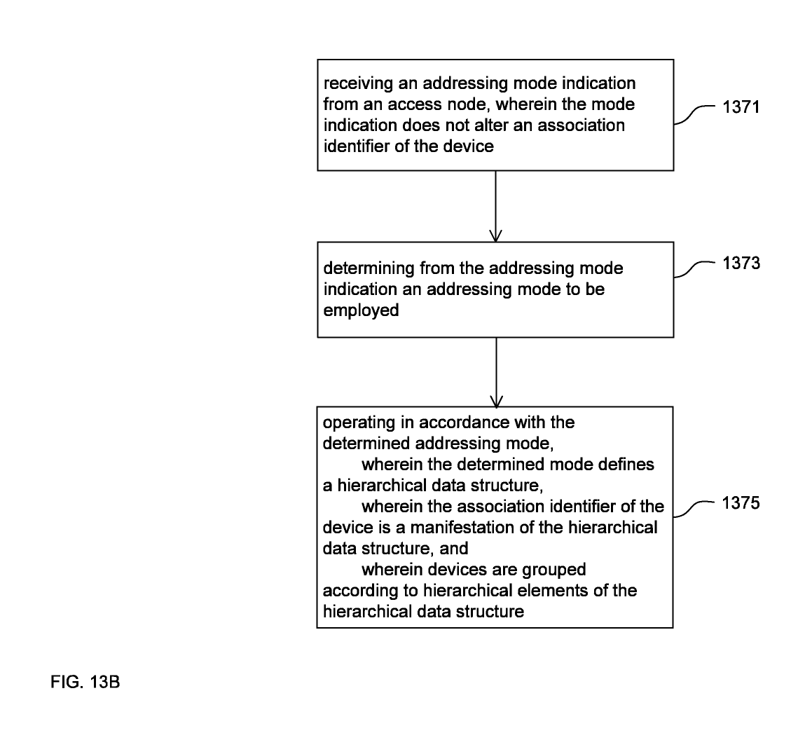

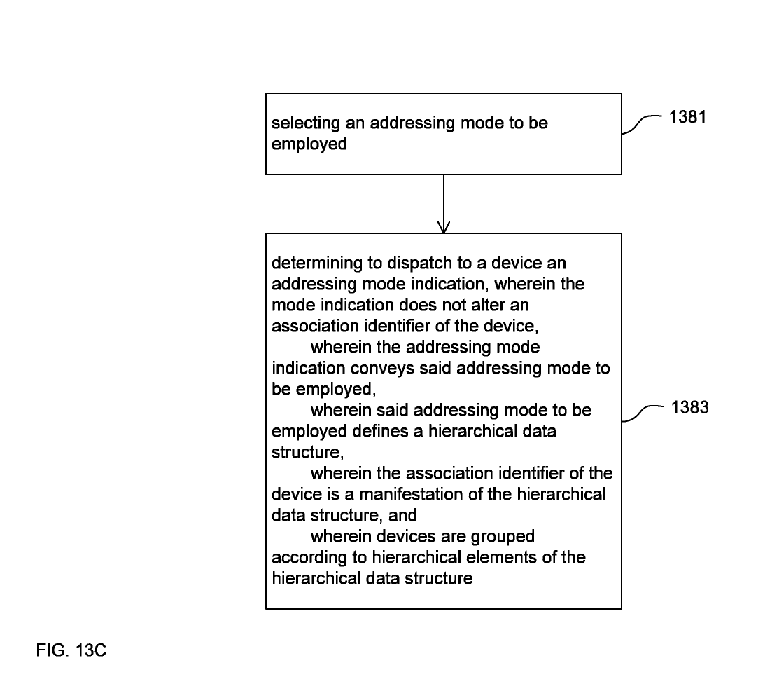

FIG. 13A is an example functional block diagram, illustrating an example AP or STA device 1300 according to an example embodiment of the invention. The example device 1300 may include a processor 1334 that may include dual or multi-core central processing units CPU_{—}1 and CPU_{—}2, a RAM memory, a ROM memory, and an interface for a keypad, display, and other input/output devices. The example device 1300 may include a protocol stack, including the transceiver 1328 and IEEE 802.11ah MAC 1342. The protocol stack may include a network layer 1340, a transport layer 1338, and an application program 1336.

In an example embodiment, the interface circuits in FIG. 13A may interface with one or more radio transceivers, battery and other power sources, key pad, touch screen, display, microphone, speakers, ear pieces, camera or other imaging devices, etc. The RAM and ROM may be optionally removable memory devices 1326 such as smart cards, subscriber identity modules (SIMs), wireless identification modules (WIMs), semiconductor memories such as RAM, ROM, PROMS, flash memory devices, etc. The processor protocol stack layers, and/or application program may be according to an example of an implementation embodied as program logic stored in the RAM and/or ROM in the form of sequences of programmed instructions which, when executed in the CPU, carry out the functions of example embodiments. The program logic may according to an example of an implementation be delivered to the writeable RAM, PROMS, flash memory devices, etc. from a computer program product or article of manufacture in the form of computer-usable media such as resident memory devices, smart cards or other removable memory devices. Alternately, they may be embodied as integrated circuit logic in the form of programmed logic arrays or custom designed ASICs. The one or more radios in the device may be separate transceiver circuits or alternately, the one or more radios may be a single RF module capable of handling one or multiple channels in a high speed, time and frequency multiplexed manner in response to the processor. Examples of removable storage media 1326 include those based on magnetic, electronic, and/or optical technologies, such as magnetic disks, optical disks, semiconductor memory circuit devices, and micro-SD memory cards (SD refers to the Secure Digital standard) for storing data and/or computer program code as an example computer program product, in accordance with at least one embodiment of the present invention.

In an example embodiment of the invention, the device 1300 of FIG. 13A is a device, comprising:

at least one processor 1334;

at least one memory, RAM, ROM, and/or removable storage 1326 including computer program code represented by the flow diagram of FIG. 13B;

the at least one memory and the computer program code configured to, with the at least one processor, cause the device 1300 at least to:

receive an addressing mode indication from an access node, wherein the mode indication does not alter an association identifier of the device;

determine from the addressing mode indication an addressing mode to be employed; and

operate in accordance with the determined addressing mode,

wherein the determined mode defines a hierarchical data structure,

wherein the association identifier of the device is a manifestation of the hierarchical data structure, and

wherein devices are grouped according to hierarchical elements of the hierarchical data structure.

FIG. 13B discloses a flow diagram in accordance with at least one example embodiment of the present invention. 1371, 1373, and 1375 of FIG. 13B as a non-limiting example represent computer code instructions stored in the RAM and/or ROM memory of device 1300, which when executed by the central processing units (CPU), carry out the functions of an example embodiment of the invention. 1371, 1373, and 1375 are performable in another order than shown and are combinable and/or separable into component operations. As such:

1371: receiving an addressing mode indication from an access node, wherein the mode indication does not alter an association identifier of the device;

1373: determining from the addressing mode indication an addressing mode to be employed; and

1375: operating in accordance with the determined addressing mode,

wherein the determined mode defines a hierarchical data structure,

wherein the association identifier of the device is a manifestation of the hierarchical data structure, and

wherein devices are grouped according to hierarchical elements of the hierarchical data structure.

In a further example embodiment of the invention, the device 1300 of FIG. 13A is a device, comprising:

at least one processor 1334;

at least one memory, RAM, ROM, and/or removable storage 1326 including computer program code represented by the flow diagram of FIG. 13C;

the at least one memory and the computer program code configured to, with the at least one processor, cause the device 1300 at least to:

select an addressing mode to be employed; and

determine to dispatch to a device an addressing mode indication, wherein the mode indication does not alter an association identifier of the device,

wherein the addressing mode indication conveys said addressing mode to be employed,

wherein said addressing mode to be employed defines a hierarchical data structure,

wherein the association identifier of the device is a manifestation of the hierarchical data structure, and

wherein devices are grouped according to hierarchical elements of the hierarchical data structure.

FIG. 13C discloses a further flow diagram in accordance with at least one example embodiment of the present invention. 1381 and 1383 of FIG. 13C as a non-limiting example represent computer code instructions stored in the RAM and/or ROM memory of device 1300, which when executed by the central processing units (CPU), carry out the functions of an example embodiment of the invention. 1381 and 1383 are performable in another order than shown and are combinable and/or separable into component operations. As such:

1381: selecting an addressing mode to be employed; and

1383: determining to dispatch to a device an addressing mode indication, wherein the mode indication does not alter an association identifier of the device,

wherein the addressing mode indication conveys said addressing mode to be employed,

wherein said addressing mode to be employed defines a hierarchical data structure,

wherein the association identifier of the device is a manifestation of the hierarchical data structure, and

wherein devices are grouped according to hierarchical elements of the hierarchical data structure.

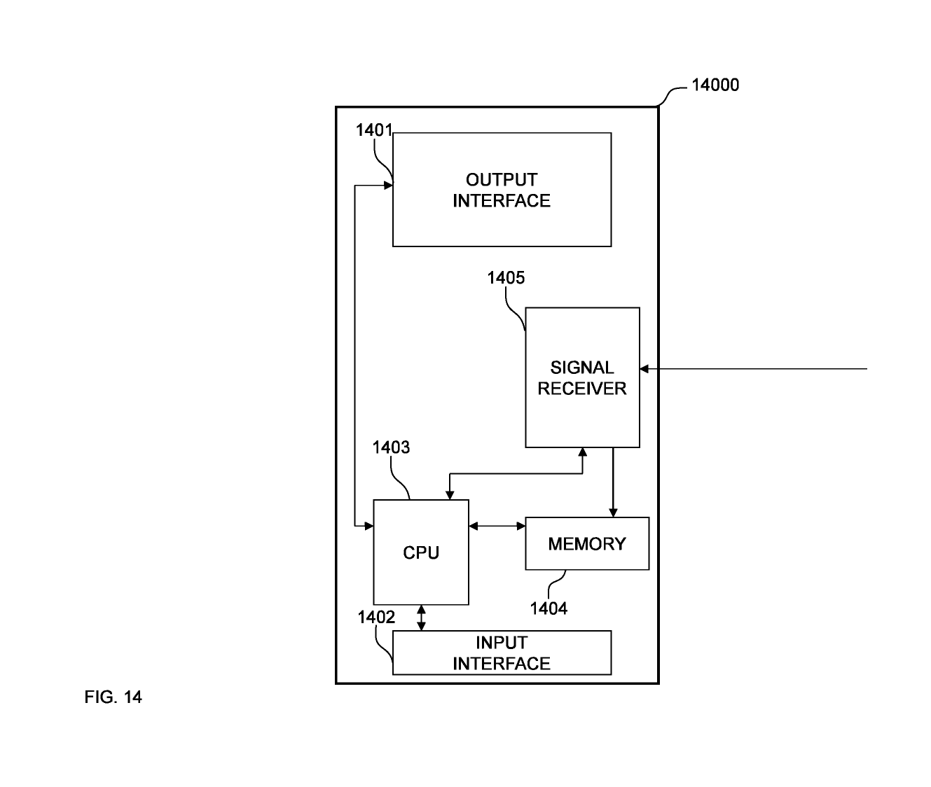

As noted, the foregoing discusses computers such as the discussed AP and STA devices. Shown in FIG. 14 is a block diagram of a further computer according to at least one example embodiment, terminal 14000. Terminal 14000 of FIG. 14 may include a processing unit CPU 1403, a signal receiver 1405, and a user interface (1401, 1402). Examples of signal receiver 1405 include single-carrier and multi-carrier receivers. Signal receiver 1405 and the user interface (1401, 1402) may be coupled with the processing unit CPU 1403. One or more direct memory access (DMA) channels may exist between multi-carrier signal terminal part 1405 and memory 1404. The user interface (1401, 1402) may include a display and a keyboard that may enable a user to use the terminal 14000. In addition, the user interface (1401, 1402) may include a microphone and a speaker for receiving and producing audio signals. The user interface (1401, 1402) may optionally employ voice recognition.

The processing unit CPU 1403 may be a microprocessor, may communicate memory 1404, and may optionally communicate with software. The software may be stored in the memory 1404. The microprocessor may control, on the basis of the software, the operation of the terminal 14000, such as receiving of a data stream, tolerance of the impulse burst noise in data reception, displaying output in the user interface and the reading of inputs received from the user interface. The hardware may contain circuitry for detecting signal, circuitry for demodulation, circuitry for detecting impulse, circuitry for blanking those samples of the symbol where significant amount of impulse noise is present, circuitry for calculating estimates, and circuitry for performing the corrections of the corrupted data.

Still referring to FIG. 14, middleware or software implementation may be optionally applied. Examples of terminal 14000 may include a hand-held device such as a cellular mobile phone which includes the multi-carrier signal terminal part 1405 for receiving multicast transmission streams. Therefore, the terminal 14000 may optionally interact with service providers.

It is noted that although APs and STAs have been discussed at various junctures in connection with IEEE 802.11 so as to facilitate ease of discussion, the APs and STAs discussed herein are not limited to IEEE 802.11 APs and STAs. Non-limiting examples of APs discussed herein may include access points (IEEE 802.11 and/or other than IEEE 802.11), access nodes, base stations, and other devices. Non-limiting examples of STAs discussed herein may include stations (IEEE 802.11 and/or other than IEEE 802.11), mobile terminals, and other devices. APs and STAs discussed herein are, as non-limiting examples, of the networking modalities discussed above in connection with input output (I/O) interfaces 12057 and 12058.

Example embodiments of the invention include an apparatus, comprising:

means for receiving an addressing mode indication from an access node, wherein the mode indication does not alter an association identifier of the apparatus;

means for determining from the addressing mode indication an addressing mode to be employed; and

means for operating in accordance with the determined addressing mode,

wherein the determined mode defines a hierarchical data structure,

wherein the association identifier of the apparatus is a manifestation of the hierarchical data structure, and

wherein devices are grouped according to hierarchical elements of the hierarchical data structure.

Example embodiments of the invention further include an apparatus, comprising:

means for selecting an addressing mode to be employed; and

means for determining to dispatch to a device an addressing mode indication, wherein the mode indication does not alter an association identifier of the device,

wherein the addressing mode indication conveys said addressing mode to be employed,

wherein said addressing mode to be employed defines a hierarchical data structure,

wherein the association identifier of the device is a manifestation of the hierarchical data structure, and

wherein devices are grouped according to hierarchical elements of the hierarchical data structure.

Still further according to the illustrative example, mode employment and/or change discussed herein may optionally occur and/or be indicated to STAs without implicit TWT assignment, without AID reassignment occurring with respect to those STAs, and/or with those STAs maintaining their AIDs. Such AID maintenance may, where mode change involves a change in AID length (e.g., from thirteen bits to fifteen bits) involve bit padding (e.g., with a STA employing padding to maintain its AID value in the face of change in specified AID length). Moreover, STAs discussed herein may optionally be TIM and/or non-TIM STAs (e.g., where mode change occurs and/or is indicated to STAs without implicit TWT assignment). Further, STAs discussed herein may optionally not be the subject of implicit TWT assignment.

### RAMIFICATIONS AND SCOPE

Although the description above contains many specifics, these are merely provided to illustrate the invention and should not be construed as limitations of the invention's scope. For instance, various examples are articulated herein via the discussion of certain aspects. Such aspects are, themselves, merely examples and should not be construed as limitations of the invention's scope. Thus it will be apparent to those skilled in the art that various modifications and variations are applicable to the system and processes of the present invention without departing from the spirit or scope of the invention.

In addition, the embodiments, features, methods, systems, and details of the invention that are described above in the application are combinable separately or in any combination to create or describe new embodiments of the invention.

What is claimed is:

1. A method, comprising:
receiving, at a device, an addressing mode indication from an access node, wherein the mode indication does not alter an association identifier of the device;
determining from the addressing mode indication, at the device, an addressing mode to be employed; and
operating, at the device, in accordance with the determined addressing mode,
wherein the determined mode defines a hierarchical data structure,
wherein the association identifier of the device is a manifestation of the hierarchical data structure, and
wherein devices are grouped according to hierarchical elements of the hierarchical data structure.

2. The method of claim 1, wherein the association identifier is employable for at least two addressing modes.

3. The method of claim 1, wherein said hierarchical elements comprise at least one of a page identifier field, a block identifier field, and a sub-block identifier field.

4. The method of claim 1, wherein the device learns from the addressing mode indication information regarding lengths of hierarchical elements of the hierarchical data structure.

5. The method of claim 1, wherein the addressing mode indication is received via one or more of beacon frame and association response.

6. A method, comprising:
selecting, at an access node, an addressing mode to be employed; and
determining to dispatch, from the access node, to a device an addressing mode indication, wherein the mode indication does not alter an association identifier of the device,
wherein the addressing mode indication conveys said addressing mode to be employed,
wherein said addressing mode to be employed defines a hierarchical data structure,
wherein the association identifier of the device is a manifestation of the hierarchical data structure, and
wherein devices are grouped according to hierarchical elements of the hierarchical data structure.

7. The method of claim 6, wherein the association identifier is employable for at least two addressing modes.

8. The method of claim 6, wherein said hierarchical elements comprise at least one of a page identifier field, a block identifier field, and a sub-block identifier field.

9. The method of claim 6, wherein the addressing mode indication conveys information regarding lengths of hierarchical elements of the hierarchical data structure.

10. The method of claim 6, wherein the addressing mode indication is dispatched via one or more of beacon frame and association response.

11. An apparatus, comprising:
at least one processor; and
at least one memory including computer program code, the at least one memory and the computer program code configured to, with the at least one processor, cause the apparatus at least to perform:
receive, at the apparatus, an addressing mode indication from an access node, wherein the mode indication does not alter an association identifier of the apparatus;
determine from the addressing mode indication, at the apparatus, an addressing mode to be employed; and
operate, at the apparatus, in accordance with the determined addressing mode,
wherein the determined mode defines a hierarchical data structure,
wherein the association identifier of the apparatus is a manifestation of the hierarchical data structure, and
wherein devices are grouped according to hierarchical elements of the hierarchical data structure.

12. The apparatus of claim 11, wherein the association identifier is employable for at least two addressing modes.

13. The apparatus of claim 11, wherein said hierarchical elements comprise at least one of a page identifier field, a block identifier field, and a sub-block identifier field.

14. The apparatus of claim 11, wherein the apparatus learns from the addressing mode indication information regarding lengths of hierarchical elements of the hierarchical data structure.

15. The apparatus of claim 11, wherein the addressing mode indication is received via one or more of beacon frame and association response.

16. An apparatus, comprising:
at least one processor; and
at least one memory including computer program code, the at least one memory and the computer program code configured to, with the at least one processor, cause the apparatus at least to perform:
select, at the apparatus, an addressing mode to be employed; and
determine to dispatch, from the apparatus, to a device an addressing mode indication, wherein the mode indication does not alter an association identifier of the device,
wherein the addressing mode indication conveys said addressing mode to be employed,
wherein said addressing mode to be employed defines a hierarchical data structure,
wherein the association identifier of the device is a manifestation of the hierarchical data structure, and
wherein devices are grouped according to hierarchical elements of the hierarchical data structure.

17. The apparatus of claim 16, wherein the association identifier is employable for at least two addressing modes.

18. The apparatus of claim 16, wherein said hierarchical elements comprise at least one of a page identifier field, a block identifier field, and a sub-block identifier field.

19. The apparatus of claim 16, wherein the addressing mode indication conveys information regarding lengths of hierarchical elements of the hierarchical data structure.

20. The apparatus of claim 16, wherein the addressing mode indication is dispatched via one or more of beacon frame and association response.
